(19) United States
(12) Patent Application Publication
(10) Pub. No.: US 2023/0170115 A1
(43) Pub. Date: Jun. 1, 2023

(54) SOFT MAGNETIC POWDER, MAGNETIC CORE, MAGNETIC COMPONENT, AND ELECTRONIC DEVICE

(71) Applicant: TDK CORPORATION, Tokyo (JP)

(72) Inventors: Yoshiki KAJIURA, Tokyo (JP); Hiroyuki MATSUMOTO, Tokyo (JP); Kazuhiro YOSHIDOME, Tokyo (JP); Satoko MORI, Tokyo (JP)

(73) Assignee: TDK CORPORATION, Tokyo (JP)

(21) Appl. No.: 17/992,409

(22) Filed: Nov. 22, 2022

(30) Foreign Application Priority Data
Nov. 29, 2021 (JP) 2021-193488

(51) Int. Cl. H01F 1/147; B22F 1/16; C22C 38/18; C22C 38/04; C22C 38/02; C22C 38/00

(52) U.S. Cl. CPC H01F 1/14766; B22F 1/16; C22C 38/18; C22C 38/04; C22C 38/02; C22C 38/002; C22C 2202/02; B22F 2301/35; B22F 2302/25

(57) ABSTRACT

A soft magnetic powder includes soft magnetic metal particles. The soft magnetic metal particles include metal particles and oxide parts covering the metal particles. Each of the metal particles at least include Fe. Each of the oxide parts at least include Fe and Mn. Concentration distributions of Mn of the soft magnetic particles have maximum concentrations of Mn in the oxide parts.

### TECHNICAL FIELD

The present invention relates to a soft magnetic powder, a magnetic core, a magnetic component, and an electronic device.

### BACKGROUND

Patent Documents 1 and 2 disclose inventions relating to amorphous soft magnetic alloys.

### [Patent Document 1] JP Application Laid Open No. 2007-231415

### [Patent Document 2] JP Application Laid Open No. 2014-167139

### SUMMARY

The object of the present invention is to provide a soft magnetic metal powder having a low coercivity which is suited for producing a magnetic core having a low Q value.

The soft magnetic metal powder according to the present invention includes the soft magnetic metal particles, wherein

the soft magnetic metal particles include metal particles and oxide parts covering the metal particles,

each of the metal particles at least include Fe,

each of the oxide parts at least include Fe and Mn, and

concentration distributions of Mn of the soft magnetic particles have maximum concentrations of Mn in the oxide parts.

When [Mn]o (at %) represents an average of the maximum concentrations of Mn of the oxide parts, and

[Mn]m (at %) represents an average concentration of Mn of the metal particles,

[Mn]o− [Mn]m≥0.2 may be satisfied.

Also, [Mn]o− [Mn]m≤7.0 may be satisfied.

Each of the metal particles may at least include Fe and Si;

each of the oxide parts may at least include Fe, Si, and Mn; and

an average concentration of Si of the oxide parts may be higher than an average concentration of Si of the metal particles.

The soft magnetic metal powder may at least include Fe and Si, and

an amount of Si may be within a range of larger than 0 at % and 10 at % or less.

A magnetic core according to the present invention includes the above-mentioned soft magnetic metal powder.

A magnetic component according to the present invention includes the above-mentioned magnetic core.

An electronic device according to the present invention includes the above-mentioned magnetic component.

### BRIEF DESCRIPTION OF THE SEVERAL VIEWS OF THE DRAWING(S)

FIG. 1 is a schematic diagram of a soft magnetic metal particle.

FIG. 2 is a graph showing a concentration distribution of each element near a surface of the soft magnetic metal particle.

FIG. 3 is a STEM image near the surface of the soft magnetic metal particle.

FIG. 4 is an element mapping of O near the surface of the soft magnetic metal particle.

FIG. 5 is an element mapping of Fe near the surface of the soft magnetic metal particle.

FIG. 6 is an element mapping of Mn near the surface of the soft magnetic metal particle.

FIG. 7 is an example of a chart obtained from X-ray crystallography.

FIG. 8 is an example of a pattern obtained by profile fitting the chart of FIG. 7.

### DETAILED DESCRIPTION

Hereinbelow, embodiments of the present invention are described using the figures, however, the present invention is not limited thereto.

### (Composition of Soft Magnetic Metal Powder)

A composition of the soft magnetic metal powder according to the present embodiment is not particularly limited, as long as the soft magnetic metal powder at least includes Fe and Mn.

The soft magnetic metal powder according to the present embodiment may be a soft magnetic metal powder including a component expressed by a compositional formula ((Fe_{1-(α+β)}Co_{α}Ni_{β})_{1-γ}X1_{γ})_{1-(a+b+c+d+e+f)}BₐP_{b}Si_{c}C_{d}CrₑMn_{f} (atomic ratio), in which

X1 is one or more selected from the group consisting of Ti, Zr, Hf, Nb, Ta, Mo, W, Al, Ga, Ag, Zn, S, Ca, Mg, V, Sn, As, Sb, Bi, N, O, Au, Cu, rare earth elements, and platinum group elements; and

0≤a≤0.250,
0≤b≤0.200,
0≤c≤0.200,
0≤d≤0.200,
0≤e≤0.060,
0<f<0.100,
α≥0,
β≥0,
0≤a+β≤1, and
0≤γ≤0.030 are satisfied.

When the compositional formula of the soft magnetic metal powder is within the above-mentioned range, the soft magnetic metal powder having a low coercivity tends to be obtained easily. Also, when 0≤a≤0.200 and 0≤e≤0.040 are satisfied, a saturation magnetization as increases.

Further, the above compositional formula may preferably satisfy

0.020≤a≤0.200,
0≤b≤0.070,
0≤c≤0.100,
0≤d≤0.050,
0≤e≤0.040,
0<f<0.030,
0≤α≤0.700,
0≤β≤0.200,
0≤γ≤0.030, and
0.720≤1−(a+b+c+d+e+f)≤0.900.

The soft magnetic metal powder satisfying the above-mentioned preferable compositional formula achieves a lower coercivity and a higher saturation magnetization as. Further, the magnetic core including such soft magnetic metal powder achieves a high Q value. Further, it becomes easy for the soft magnetic metal powder to have a structure made of amorphous or a structure made of nanocrystal as mentioned in below.

In below, each component of the soft magnetic metal powder according to the present embodiment is described in detail.

An amount (a) of B may be within a range of 0≤a≤0.250, within range of 0≤a≤0.200, or within a range of 0.020≤a≤0.200.

An amount (b) of P may be within a range of 0≤b≤0.200, within a range of 0≤b≤0.080, or within a range of 0≤b≤0.070.

An amount (c) of Si may be within a range of 0≤c≤0.200, within a range of 0≤c≤0.110, or within a range of 0≤c≤0.100.

An amount (d) of C may be within a range of 0≤d≤0.200, within a range of 0≤d≤0.060, or within a range of 0≤d≤0.050.

An amount (e) of Cr may be within a range of 0≤e≤0.060, within a range of 0≤e≤0.050, or within a range of 0≤e≤0.040.

An amount (f) of Mn may be within a range of 0<f<0.100, within a range of 0<f<0.030, or within a range of 0<f<0.030. Further, it may be within a range of 0.00001<f<0.028, within a range of 0.00005<f<0.028, or within a range of 0.001<f<0.028.

An amount (α) of Co to a total amount of Fe, Co, and Ni is within a range of α≥0. An amount (β) of Ni to a total amount of Fe, Co, and Ni is within a range of β≥0. Further, 0≤α+β≤1 is satisfied.

Regarding a, it may be within a range of 0≤α≤0.800, or may be within a range of 0≤α≤0.700. Regarding 3, it may be within a range of 0≤β≤0.250, or may be within a range of 0≤β≤0.200.

X1 is one or more selected from the group consisting of Ti, Zr, Hf, Nb, Ta, Mo, W, Al, Ga, Ag, Zn, S, Ca, Mg, V, Sn, As, Sb, Bi, N, O, Au, Cu, rare earth elements, and platinum group elements. Note that, the rare earth elements include Sc, Y, and lanthanoids. The platinum group elements include Ru, Rh, Pd, Os, Ir, and Pt. X1 may be included as impurities, or it may be added intentionally. An amount (γ) of X1 to a total amount of Fe, Co, Ni, and X1 may be within a range of 0≤γ<0.030, or it may be within a range of 0≤γ≤0.025.

The total amount (1−(a+b+c+d+e+f)) of Fe, Co, Ni, and X1 may be within a range of 0.710≤1−(a+b+c+d+e+f)≤0.910, or within a range of 0.720≤1−(a+b+c+d+e+f)≤0.900.

The soft magnetic metal powder according to the present embodiment may include elements other than mentioned in above as inevitable impurities. Specifically, the elements other than the group consisting of Fe, Co, Ni, X1, B, P, Si, C, Cr, and Mn may be included as the inevitable impurities. For example, such inevitable impurities may be included in an amount of 0.1 mass % or less to 100 mass % of the soft magnetic metal powder.

### (Surface Structure of Soft Magnetic Metal Particle)

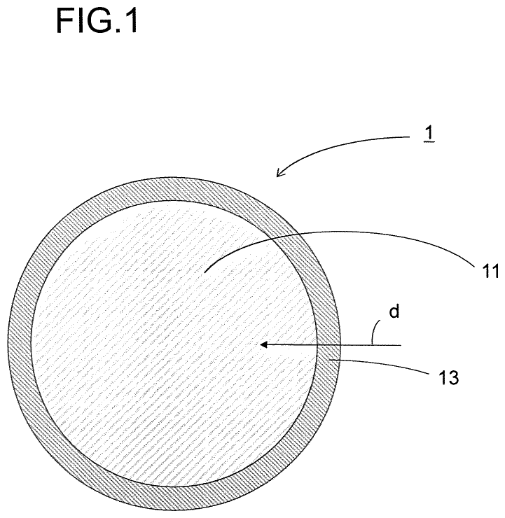

The soft magnetic metal powder according to the present embodiment includes soft magnetic metal particles 1. As shown in FIG. 1, the soft magnetic metal particle 1 includes a metal particle 11, and an oxide part 13 covering the metal particle 11. The soft magnetic metal particle 1 may be constituted only from the metal particle 11 and the oxide part 13. Also, the metal particle 11 may or may not include a crystal.

A shape of the oxide part 13 is not particularly limited, and the shape of the oxide part 13 may be a layered shape. Also, the oxide part 13 does not necessarily have to cover the entire surface of the metal particle 11. The oxide part 13 may cover 50% or more of the surface of the metal particle 11.

The metal particle 11 of which the oxide part is covering 50% or more of the surface of the particle is referred as a covered particle, and the metal particle 11 of which the oxide part 13 is not covering 50% or more of the surface is referred as a non-covered particle.

The soft magnetic metal powder may only include the covered particles, or it may include both the covered particles and the non-covered particles. The larger the number ratio of the covered particles in the soft magnetic metal powder is, the coercivity of the soft magnetic metal powder tends to decrease easier. The number ratio of the covered particles in the soft magnetic metal powder is not particularly limited, and it may be 90% or more and 100% or less, or it may be 95% or more and 100% or less.

The metal particle 11 at least includes Fe. The metal particle 11 may at least include Fe and Si. Soft magnetic properties of the soft magnetic metal powder vary depending on the composition of the metal particle 11. When the soft magnetic metal powder has excellent soft magnetic properties, a relative permeability is high, as is high, and a coercivity is low.

The oxide part 13 at least includes Fe and Mn. The oxide part 13 may at least include Fe, Mn, and Si. Also, the oxide part 13 may include, an oxide of Fe, an oxide of Mn, and/or an oxide of Si. Further, the oxide part 13 may include an oxide of another element as well.

Regarding the concentration distribution of Mn of the soft magnetic metal particle 1 included in the soft magnetic powder, the maximum concentration of Mn is found in the oxide part 13. That is, concentration distributions of Mn differ in the metal particle 11 and in the oxide part 13. Note that, in below, said maximum concentration may be referred as a maximum Mn.

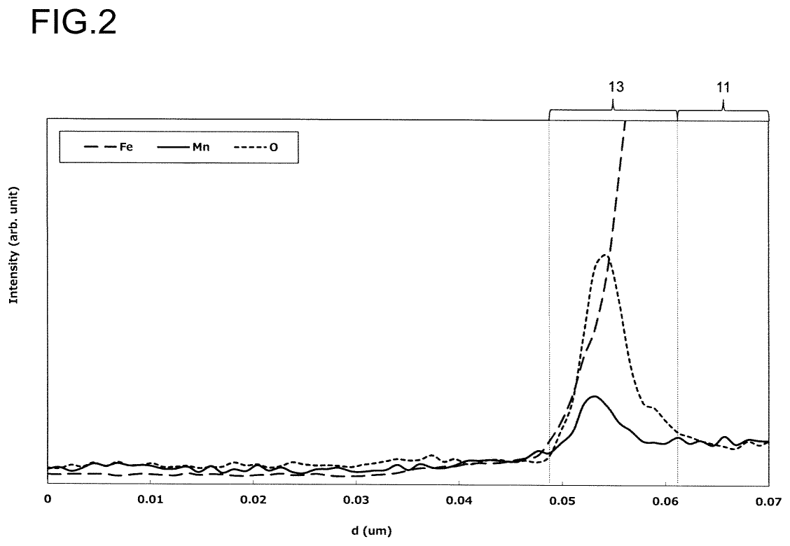

The concentration distribution of each element near the surface of the soft magnetic metal particle 1 is shown in FIG. 2. FIG. 2 is a graph showing a measurement result of the concentration distributions of Fe, Mn, and O along a perpendicular direction to the outer most surface of the soft magnetic metal particle 1, that is, along a depth direction d of FIG. 1. Detail is described in below, and for example, the measurement of each element is carried out using EDS. A vertical axis of FIG. 2 shows an intensity of a detection characteristic X-ray of each element. The intensity of detection characteristic X-ray of each element is proportional to the concentration of the element. In FIG. 2, the area showing a large increase in the concentration of O is the oxide part 13. Also, the concentrations of Fe, Mn, and O while d is further increased do not significantly change from the concentrations of Fe, Mn, and O at d=0.07 um. Therefore, according to FIG. 2, it can be understood that the concentration distribution of Mn of the soft magnetic particle 1 has a maximum value in the oxide part 13. Note that, the graph shown in FIG. 2 is a graph which is obtained while analyzing Sample No. 21 of Examples described in below.

The soft magnetic metal powder satisfies [Mn]o>[Mn]m, in which [Mn]o (at %) represents an average of the maximum Mn of the oxide parts 13, and [Mn]m (at %) of an average of the concentrations of Mn from the metal particles 11. That is, Mn is concentrated in the oxide part 13 which is covering the metal particle 11. Note that, [Mn]o− [Mn]m≥0.1 may be satisfied.

Since Mn is concentrated in the oxide part 13 of the soft magnetic metal particle 1, an insulation property of the oxide part 13 is enhanced. As a result, a high frequency property of the soft magnetic metal powder including the soft magnetic metal particles 1 is enhanced, and the coercivity decreases. Further, a Q value of the magnetic core including the soft magnetic metal powder is enhanced.

Further, the soft magnetic metal powder may satisfy [Mn]o− [Mn]m≥0.2. In this case, the coercivity decreases further easily, and the Q value of the magnetic core including the soft magnetic metal powder tends to enhance easily.

Although, the upper limit of [Mn]o− [Mn]m is not particularly limited, the soft magnetic metal powder may satisfy [Mn]o− [Mn]m≤7.0. In this case, the coercivity tends to further decrease easily.

An average concentration of Si of the oxide parts 13 may be larger than an average concentration of Si of the metal particles 11. Specifically, [Si]o−[Si]m≥0.1 may be satisfied, in which [Si]o (at %) represents an average concentration of Si of the oxide parts 13, and [Si]m (at %) represents an average concentration of Si of the metal particles 11. When the average concentration of Si of the oxide parts 13 is larger than the average concentration of Si of the metal particles 11, the Q value of the magnetic core tends to enhance easily.

The average concentration of Si of the soft magnetic metal powder may be within a range of larger than 0 at % and 20 at % or less, or may be larger than 0 at % and 10 at % or less. When the soft magnetic metal powder substantially only includes the component expressed by the above compositional formula of ((Fe_{1-(α+β)}Co_{α}Ni_{β})_{1-γ}X1_{γ})_{1-(a+b+c+d+e+f)}BₐP_{b}Si_{c}C_{d}CrₑMn_{f} (atomic ratio), then c may be within a range of 0<c≤0.200, or within a range of 0<c≤0.100. As the soft magnetic metal powder includes Si within the above-mentioned range, as of the soft magnetic metal powder tends to enhance easily.

An average particle size of the soft magnetic metal particles included in the soft magnetic metal powder is not particularly limited. For example, it may be within a range of 1 um or more and 150 um or less.

### (Method of Analyzing Surface Structure of Soft Magnetic Metal Particle)

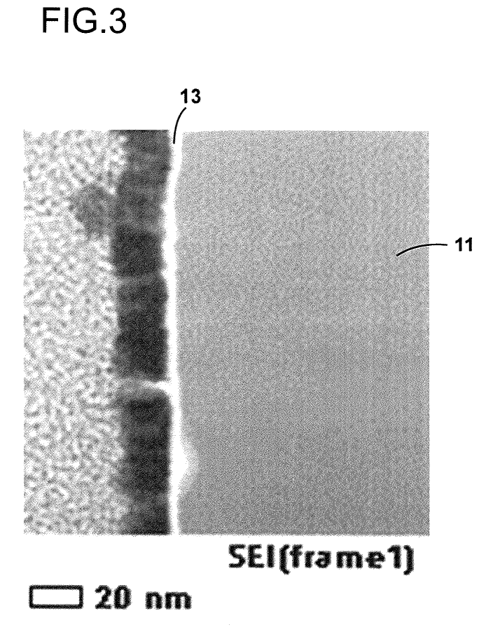

A method of analyzing the surface structure of the soft magnetic metal particle 1 is not particularly limited. For example, a cross section of the soft magnetic metal particle 1 may be observed using STEM (scanning transmission electron microscope). FIG. 3 shows a STEM image near the surface of the soft magnetic metal particle 1. According to FIG. 3, the metal particle 11, the oxide part 13, and an outside area of the soft magnetic metal particle 1 can be identified respectively.

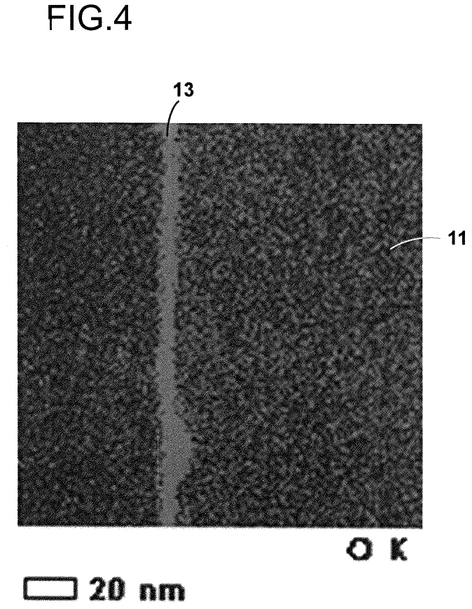

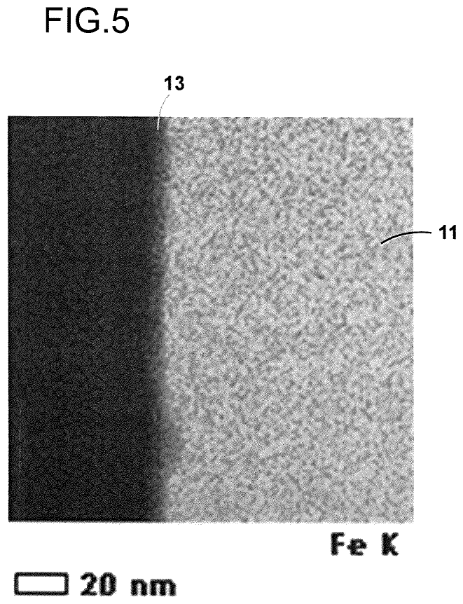

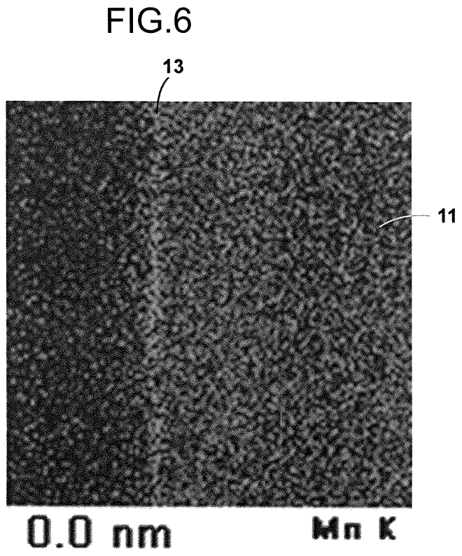

The concentration distribution of each element can be measured using EDS (Energy Dispersion X-ray Spectroscopy). FIG. 4 to FIG. 6 show the element mapping images of O, Fe, and Mn. Particularly according to FIG. 6, it can be understood that the concentration distribution of Mn in the soft magnetic metal particle 1 has a maximum concentration in the oxide part 13.

Also, a graph shown in FIG. 2 is made using STEM and EDS, and the maximum Mn can be measured. In reality, among number of measured values of Mn used for making the graph, the highest measured value is defined as the maximum Mn. Further, the average [Mn]o of the maximum values of Mn of the soft magnetic metal powder is an average of the maximum values of Mn of the soft magnetic metal particles 1 included in the soft magnetic metal powder. Also, the number of observation points in one soft magnetic metal particle 1 is not particularly limited. The number of observation points of one soft magnetic metal particle may be 1 or may be 2 or more. Also, the number of soft magnetic metal particles to be observed is also not particularly limited. For example, 5 or more soft magnetic metal particles may be arbitrarily selected from the soft magnetic metal powder for observation, or 20 or more soft magnetic metal particles may be arbitrarily selected.

For the analysis of the surface structure of the soft magnetic metal particle, a transmission electron microscope (TEM) may be used instead of STEM. Also, an electron energy loss spectroscope (EELS) and so on may be used for the analysis instead of EDS.

The metal particle 11 and the oxide part 13 may be identified based on the concentration of O. For example, the average concentration of O of the metal particle 11 is calculated, and the area having a higher concentration of O near the surface of the soft magnetic metal particle 1 than the average concentration of O of the metal particle 11 may be considered as the oxide part 13.

The concentrations of Mn of the metal particles 11 of the soft magnetic metal particles 1 included in the soft magnetic metal powder are measured and the average thereof is calculated, thereby the average Mn concentration [Mn]m of the metal particles 11 can be obtained.

The concentrations of Si of the oxide parts 13 of the soft magnetic metal particles 1 included in the soft magnetic metal powder are measured and the average thereof is calculated, thereby the average concentration of Si of the oxide parts 13 can be obtained.

The concentrations of Si of the metal particles 11 of the soft magnetic metal particles 1 included in the soft magnetic metal powder are measured and the average thereof is calculated, thereby the average concentration of Si of the metal particles 11 can be obtained.

Usually, the concentration of each element of the soft magnetic metal powder and the average concentration of each element of the metal particles 11 roughly match with each other. Usually, the oxide part 13 is extremely small compared to the metal particle 11, this is because most part of the soft magnetic metal powder is the metal particle 11.

### (Fine Structure of Soft Magnetic Metal Powder)

The soft magnetic metal powder preferably may have a structure made of amorphous or a structure made of nanocrystal. When the soft magnetic metal powder has the structure made of amorphous or the structure made of nanocrystal, the coercivity of the soft magnetic metal powder is lower compared to the case that the soft magnetic metal powder has a structure made of crystal. Further, the Q value of the magnetic core including the soft magnetic metal powder increases.

The structure made of amorphous means that an amorphous ratio X which can be observed using XRD is 85% or more. The structure having a high amorphous ratio X, in other words, the structure made of amorphous means a structure only made of amorphous or a structure made of heteroamorphous. The structure made of heteroamorphous means a structure having a fine crystal exists in amorphous. An average particle size of the fine crystals included in the structure of the heteroamorphous is not particularly limited. For example, the average particle size of the fine crystals is roughly within a range of 0.1 nm or more and 30 nm or less.

The structure made of nanocrystal is a structure which mainly includes nanocrystals. In the structure made of crystals and the structure made of nanocrystals, the amorphous ratio X which can be observed using XRD is less than 85%. The average particle size of nanocrystals in the structure made of nanocrystals is within a range of 0.5 nm or more and 30 nm or less. The average particle size of the crystals of the structure made of crystals is larger than 30 nm. The average particle size of the crystals included in the soft magnetic powder can be verified using XRD.

Specifically, the soft magnetic powder having 85% or larger amorphous ratio X shown by a below Equation (1) has a structure made of amorphous; and the soft magnetic metal powder having less than 85% of amorphous ratio X has a structure made of nanocrystals or crystals.

X=100−(Ic/(Ic+Ia)×100) Equation (1)

Ic: Crystal scattering integrated intensity

Ia: Amorphous scattering integrated intensity

An X-ray crystallography of the soft magnetic metal powder is carried out using XRD to determine a phase, and a peak of crystallized Fe or a peak of a crystallized compound is read (Ic: Crystal scattering integrated intensity, Ia: Amorphous scattering integrated intensity). Then, from the peak intensity, a crystal ratio is obtained, and the amorphous ratio is calculated using the above-mentioned Equation (1). In below, a method of calculation is described in further detail.

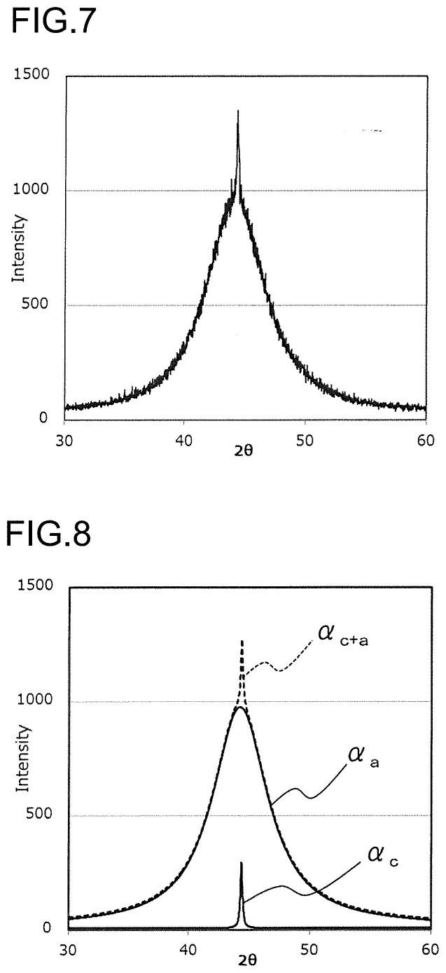

The X-ray crystallography of the soft magnetic metal powder according to the present embodiment is carried out using XRD, and thereby obtains a chart as shown in FIG. 7. This is profile fitted using a Lorentz function represented by the following Equation (2). As a result of this profile fitting, a crystal component pattern ac which indicates a crystal scattering integrated intensity, an amorphous component pattern αₐ which indicates an amorphous scattering integrated intensity, and a pattern α_{c+a} which is a combination of these two are obtained, as shown in FIG. 8. From the obtained crystal scattering integrated intensity and amorphous scattering integrated intensity, the amorphous ratio X is obtained using the above-mentioned Equation (1). Here, a measurement range of a diffraction angle 2θ may preferably be set to a range in which amorphous-derived halos can be confirmed, for example within a range of 2θ=30° to 60°. Within this range, the integrated intensities actually measured using XRD and the integrated intensities calculated using the Lorentz function may differ preferably within 1%.

$$\begin{matrix}[ Formula 1 ] & \\ f ( x ) = \frac{h}{1 + \frac{{( x - u )}^{2}}{{w}^{2}}} + b & ( Equation 2 )\end{matrix}$$

h: Peak height
u: Peak position
w: Half bandwidth
b: Background height

### (Coating Part)

In addition to the metal particle 11 and the oxide part 13, the soft magnetic metal particle 1 may further include a coating part which covers the oxide part 13. The coating part may be an insulation coating. A type of the coating part is not particularly limited, and it may be any coating part formed by coating which is usually used in the technical field of the present embodiment. As the type of the coating part, for example, iron-based oxides, phosphates, silicates (water glass), soda-lime glass, borosilicate glass, lead glass, aluminosilicate glass, borate glass, sulfate glass, and the like may be mentioned. As phosphates, for example, magnesium phosphate, calcium phosphate, zinc phosphate, manganese phosphate, and cadmium phosphate may be mentioned. As one of silicates, sodium silicate may be mentioned. Also, a thickness of the coating part is not particularly limited, and the thickness may be within a range of 5 nm or more and 100 nm or less on average.

### (Method of Producing Soft Magnetic Metal Powder)

The soft magnetic metal powder according to the present embodiment can be produced using a gas atomization method. Details of a gas atomization method is as described in below.

A pure substance of each element included in the soft magnetic metal powder obtained at the end is prepared, and said pure substance is weighed so that the composition is the same as the composition of the soft magnetic metal powder obtained at the end. Further, the pure substance of each element is melted to produce a mother alloy. Note that, a method of melting the pure substance is not particularly limited, and for example, a method of melting which uses high frequency heating after vacuuming inside the chamber may be used. Note that, usually the compositions of the mother alloy and soft magnetic metal powder obtained at the end are the same.

Next, the produced mother alloy is heated and melted to obtain a molten. A temperature of the molten is not particularly limited, and for example, it can be within a range of 1000° C. to 1500° C. Then, the molten is sprayed at the inside of the chamber and the powder is formed. Specifically, the melted mother alloy is exhausted from an exhaust port towards a cooling part, and a high-pressured gas is sprayed to exhausted molten metal drops. As the molten metal drops collied against the cooling part (cooling water), the molten metal drops cool solidify and form the soft magnetic metal powder.

A type of high-pressured gas is not particularly limited. For example, N₂ gas, Ar gas, and the like may be mentioned.

Here, the heating temperature of the high-pressured gas is set higher than usual temperature, and the oxygen concentration of the high-pressured gas is set higher than usual concentration, and thereby Mn can be concentrated in the surface of the soft magnetic metal particle. As a result, the soft magnetic metal powder of which the concentration distribution of Mn of the soft magnetic metal particle has the maximum concentration of Mn in the oxide part can be obtained.

The higher the heating temperature of the high-pressured gas is, the easier it is to obtain the soft magnetic metal powder of which the concentration distribution of Mn of the soft magnetic metal particle has the maximum concentration of Mn in the oxide part. The higher the oxygen concentration is, the easier it is to obtain the soft magnetic metal powder of which the concentration distribution of Mn of the soft magnetic metal particle has the maximum concentration of Mn in the oxide part.

The heating temperature of the high-pressured gas may for example be 250° C. or higher. The oxygen concentration of the high-pressured gas may be 0.01% or higher, 0.10% or higher, or 0.25% or higher.

The upper limit of the heating temperature of the high-pressure gas is not particularly limited. However, when the heating temperature of the high-pressured gas is too high, the particle size of the obtained soft magnetic metal powder decreases. As a result, the permeability of the magnetic core including the soft magnetic metal powder tends to decrease easily. Therefore, for example, the heating temperature of the high-pressured gas may be 400° C. or lower, or 300° C. or lower.

The upper limit of the oxygen concentration of the high-pressured gas is not particularly limited. However, when the oxygen concentration of the high-pressured gas is too high, the oxide part of the soft magnetic metal particle included in the soft magnetic metal powder becomes too thick. As a result, the permeability of the magnetic core including the soft magnetic metal powder tends to decrease easily. Therefore, for example, the oxygen concentration of the high-pressured gas may be 5.00% or less, or 1.00% or less.

The obtained soft magnetic metal powder may be heat treated under active atmosphere or inert atmosphere.

The soft magnetic metal powder prior to the heat treatment usually has a structure made of amorphous. Although it may change depending on the composition of the soft magnetic metal powder, when the soft magnetic metal powder having a structure made of amorphous is heat treated within a range of 100° C. to 400° C., the coercivity can be lowered while maintaining the structure made of amorphous. Also, when the soft magnetic metal powder is heat treated within a temperature range of 400° C. to 650° C., the soft magnetic metal powder having a structure made nanocrystal is obtained.

When the heat treatment is carried out under active atmosphere, the oxide part can be made thicker. The upper limit of the thickness of the oxide part is not particularly limited. However, in case the oxide part is too thick, the permeability tends to decrease easily when the magnetic core is produced. When a molding pressure is increased in order to increase the permeability, a stress is generated and the Q value of the magnetic core tends to decrease easily. The thickness of the oxide part may be 500 nm or less, 100 nm or less, 20 nm or less, or 10 nm or less.

Further, when the coating part which covers the oxide part 13 is formed, the coating part is formed accordingly. A method of forming the coating part is not particularly limited, and a method which is usually used in the technical field of the present embodiment may be used.

### (Magnetic Core)

Next, a method of forming the magnetic core including the soft magnetic metal powder is described.

By molding the soft magnetic metal powder, the magnetic core can be obtained. A method of molding is not particularly limited. As one example, a method of obtaining the magnetic core using pressure molding is described.

Regarding the soft magnetic metal powder used for the pressure molding, the soft magnetic metal particles of large sizes may be removed using classification. The larger the particle size of the soft magnetic metal particle is, the coercivity tends to become higher. Further, the larger the particle size of the soft magnetic metal particle is, the coercivity of the soft magnetic metal particle tends to have a larger impact on the properties of the magnetic core. That is, by removing the soft magnetic metal particles of large sizes using classification, the coercivity of the used soft magnetic metal powder can be lowered, and the properties of the obtained magnetic core can be enhanced. However, if the soft magnetic metal particles of large sizes are removed too much using classification, the permeability of the obtained magnetic core decreases. Further, when the molding pressure is increased in order to increase the permeability, stress is caused and the Q value of the magnetic core tends to decrease easily.

Hence, the soft magnetic metal powder may be used which is classified using a sieve having a sieve size of 20 um or larger and 90 um or smaller may be used.

The soft magnetic metal powder and the resin are mixed. By mixing the resin, a green compact with even higher strength can be easily obtained during the pressure molding. A type of the resin is not particularly limited. For example, a phenol resin, an epoxy resin, and the like may be mentioned. The added amount of the resin is not particularly limited. When the resin is added, it may be added within a range of 1 mass % or more and 5 mass % or less to the amount of the magnetic powder.

A granulated powder is obtained by granulating a mixed product of the soft magnetic metal powder and the resin. A method of granulation is not particularly limited. For example, a stirrer may be used for granulation. A particle size of the granulated powder is not particularly limited, and for example, it may be within a range of 100 um or larger and 1000 um or smaller.

The obtained granulated powder is pressure molded to obtain the green compact. A molding pressure is not particularly limited. For example, a surface pressure may be within a range of 1 ton/cm² or more and 10 ton/cm² or less. The higher the compacting pressure is, it tends to be easier to obtain a higher relative permeability of the obtained magnetic core.

Further, the resin included in the green compact is cured and the magnetic core can be obtained. A method of curing is not particularly limited. A heat treatment may be carried out under the conditions which can cure the used resin.

A method of verifying the composition of the soft magnetic metal powder is not particularly limited. For example, ICP (Inductively Coupled Plasma) can be used. Also, in case the oxygen amount is difficult to determine by using ICP, an impulse heat melting extraction method can be used together. When the carbon amount and the sulfur amount are difficult to determine using ICP, an infrared absorption method can be used together.

Regarding, the soft magnetic alloy powder and the like included in the magnetic core, in which the soft magnetic alloy powder, the resin, and the like are mixed, in some cases it may be difficult to determine the composition of the soft magnetic alloy by using ICP and the like mentioned in the above. In such case, the composition may be determined by EDS (Energy Dispersive Spectroscopy) analysis or EPMA (Energy Probe Microanalyzer) analysis using an electron microscope. Note that, in some cases, a detailed composition may be difficult to determine by EDS analysis and EPMA analysis. For example, a resin component in the magnetic core may influence the measurement. Also, in case the magnetic core requires processing, such processing itself may influence the measurement.

In case the composition is difficult to be determined by the above-mentioned ICP, an impulse heat melting extraction method, EDS, and the like; 3DAP (three-dimensional atom probe) may be used to determine the composition. In case of using 3DAP, the composition of the soft magnetic metal powder can be measured by excluding the influence of the resin component, a surface oxidation, and the like from the area to be analyzed. This is because a small area such as an area of φ20 nm×100 nm can be set in the soft magnetic alloy powder to measure an average composition.

The magnetic core obtained using the above-mentioned method attains a low coercivity and a high saturation magnetic flux density, and also attains excellent Q value.

### (Magnetic Component, Electronic Device)

The magnetic component according to the present embodiment includes the above-mentioned magnetic core. A type of the magnetic component is not particularly limited. For example, an inductor, a transformer, and the like may be mentioned. Particularly, the magnetic component according to the present embodiment is suited for a use which requires a low power consumption and an enhanced efficiency.

The electronic device according to the present embodiment includes the above-mentioned magnetic component. A type of the electronic device is not particularly limited. For example, a personal computer, a smartphone, an electronic game device, and the like may be mentioned. Particularly, the electronic device according to the present embodiment is suited for a use which requires a low power consumption and an enhanced efficiency.

### EXAMPLES

Hereinbelow, the present invention is described based on further detailed examples. However, the present invention is not limited thereto.

### Experiment Example 1

### (Production of Soft Magnetic Metal Powder)

In order to obtain a mother alloy satisfying a composition shown in the below table, ingots of various materials were prepared and weighed. Then, the ingots were placed inside a container in a gas atomization apparatus. Next, using a coil provided outside of the container, a crucible was heated to 1500° C. under inert atmosphere to melt and mix the ingots inside the crucible, thereby a molten was obtained.

In the tables shown in below, for the experiment examples of which an amount (f) of Mn was 0.000 by rounding off at fourth decimal points, only the amount (f) of Mn was indicated to the fifth decimal points. Also, “1−(a+b+c+d+e+f)”, which represents a total amount of Fe, Co, Ni, and X1, was simply indicated as A.

Next, a molten inside the crucible was spouted out from a nozzle provided to the crucible, and at the same time, N₂ gas as a high-pressured gas at a gas pressure of 5 MPa was collied against the spouted molten for quenching, and thereby the soft magnetic metal powder was obtained. Here, a heating temperature of the high-pressured gas and an oxygen concentration in the high-pressured gas were as shown in each table.

ICP analysis was used to confirm that the composition of the mother alloy and the composition of the soft magnetic metal powder matched with each other.

Using methods shown in below, a soft magnetic metal powder of each sample number was analyzed.

### (Observation of Surface Structure of Soft Magnetic Metal Particle)

A mixed product of the soft magnetic metal powder and a heat curing resin was molded. Further, the heat curing resin was cured to obtain a green compact. Next, the obtained green compact was processed using ion milling, and a thin film (measuring sample) was obtained.

The thin film was observed using STEM, 20 soft magnetic metal particles were arbitrarily selected from the soft magnetic metal particles included in the thin film. Then, the cross sections of the arbitrarily selected soft magnetic metal particles were observed.

The concentration distribution of each element in each of the soft magnetic metal particle was measured. The concentration distribution of each element was measured along the direction perpendicular to the outer most surface of the soft magnetic metal particle. That is, as shown in FIG. 1, the concentration distribution of each element was measured along a line which extended along a depth direction d and transversely crossing the soft magnetic metal particle 1. The concentration of each element was measured roughly every 1 nm. The concentration distribution of each element was measured using EDS.

It was verified whether the average concentration of Si of the oxide parts from twenty soft magnetic metal particles was higher than the average concentration of Si in the metal particles from twenty soft magnetic metal particles. When the average of the concentrations of Si of the oxide parts from the twenty soft magnetic metal particles was higher than the average concentration of Si of the metal particles from the twenty oft magnetic metal particles, the column of “oxide part Si” was indicated “present”. When the average concentration of Si of the oxide parts from the twenty soft magnetic metal particles was equal or lower than the average concentration of Si of the metal particles from the twenty soft magnetic metal particles, then the column of “Oxide part Si” was indicated as “present”.

Regarding each of the twenty soft magnetic metal particles, it was verified whether the concentration distribution of Mn had the maximum concentration of Mn in the oxide part. Then, the average of the maximum concentrations was defined as [Mn]o (at %). Further, the average concentration of Mn of the metal particles was defined as [Mn]m (at %).

When the concentration distribution of Mn had the maximum concentration in the oxide part, then the column “Mn Maximum” was indicated “present”. When the concentration distribution of Mn did not have the maximum concentration in the oxide part, then the column “Mn Maximum” was indicated “not present”.

Calculation results of [Mn]o− [Mn]m are shown in each table. Note that, when the concentration distribution of Mn did not have the maximum concentration in the oxide part, that is, when the concentration distribution of Mn steadily decreased from the boundary between the metal particle and the oxide part in the oxide part, the concentration of Mn at the boundary between the metal particle and the oxide part was defined as the maximum concentration of Mn for convenience, thereby [Mn]o was calculated. Results are shown in each table.

### (Verification of Fine Structure of Soft Magnetic Metal Powder)

The obtained soft magnetic metal powder was subjected to X-ray diffraction measurement to calculate an amorphous ratio X. When the amorphous ratio X was 85% or more, it was considered that the structure was made of amorphous. When the amorphous ratio X was less than 85% and the average particle size was smaller than 30 nm, it was considered that the structure was made of nanocrystal. When the amorphous ratio X was less than 85% and the average particle size was larger than 30 nm, then it was considered that the structure was made of crystal. Regarding Experiment example 1, the soft magnetic metal powders of all examples had structures made of amorphous.

### (Measurement of σs)

The soft magnetic metal powder of each sample was classified using a sieve of 53 um, and the soft magnetic metal powder which passed through the sieve was used.

75 mg of the soft magnetic metal powder and paraffin were placed in a plastic case of a cylinder shape. An inner diameter cp of a plastic case was 6 mm and a height of the plastic case was 5 mm. The paraffin inside the plastic case was melted by heating, then the paraffin was solidified, and thereby obtained a measurement sample. For the measurement of as, VSM (Vibrating Sample Magnetometer) made by TAMAGAWA CO., LTD was used. Results are shown in each table. When σs was 1.20 T or larger, it was considered good, 1.30 T or larger was considered even better, and 1.50 T or larger was considered particularly good.

### (Measurement of Coercivity)

The soft magnetic metal powder of each sample was classified. For classification, the soft magnetic metal powder was passed through a sieve of 53 um, a sieve of 32 um, and a sieve of 20 um in this order. The powder which passed through the sieve of 20 um was defined as a small particle powder; the powder which passed through the sieve of 32 um and did not pass through the sieve of 20 um was defined as a medium particle powder; and the powder which passed though 53 um and did not pass through the sieve of 32 um was defined as a large particle powder. Then, the coercivity of each powder was measured, and the coercivity of the small particle powder was considered Hc1, the coercivity of the medium particle powder was considered Hc2, and the coercivity of the large particle powder was considered Hc3. As a measurement device, K-HC1000 made by TOHOKU STEEL CO., LTD was used, and a magnetic field measurement was set to 150 kA/m. When all of Hc1 to Hc3 showed the coercivity of 5.00 Oe or less, it was considered good; and when all of Hc1 to Hc3 showed coercivity of 2.50 Oe or less, it was considered even better.

### (Production of Magnetic Core, and Measurement of Relative Permeability and Q Value)

The soft magnetic metal powder of each sample was classified using a sieve of 53 um, and the soft magnetic metal powder which passed through the sieve was used.

The resin was weighed so that it was 2 parts by mass to 100 parts by mass of the soft magnetic metal powder, and these were mixed. As the resin, a phenol resin was used.

Next, the soft magnetic metal powder was granulated, and obtained a granulated powder. The granulated powder was formed so that the particle size was about 500 um or so using a planetary mixer.

The obtained granulated powder was pressure molded to produce a magnetic core of toroidal shape (an outer diameter of 11 mmφ, an inner diameter of 6.5 mmφ, and a height of 6.0 mm). A surface pressure was regulated so that the relative permeability of the magnetic core was within a range of 33.0 to 34.0. Note that, in all of the experiment examples, the surface pressure was within a range of 2 ton/cm² or higher and 10 ton/cm² or lower (192 MPa or more and 980 MPa or less). The Q value of the magnetic core of each experiment example having about the same relative permeability was measured and compared.

The wire was wound in twelve turns around the magnetic core and the relative permeability and the Q value were measured using a LCR meter (LCR428A made by HP). The measurement frequency was 3 MHz. The Q value of 27.0 or larger was considered good, 30.0 or larger was considered even better, and 35.0 or larger was considered particularly good.

TABLE 1

| | | Fe₁₋(_{a+b+c+d+e+f})BₐP_{b}Si_{c}C_{d}CrₑMn_{f}, | | | | | | | | | |
|---|---|---|---|---|---|---|---|---|---|---|---|
| | Example/ | α = 0, β = 0, γ = 0 | | | | | | | Gas Heating | Gas Oxygen | |
| Sample | Comp. | Fe | B | P | Si | C | Cr | Mn | Temp. | Concentration | Oxide part |
| No | example | A | a | b | c | d | e | f | (° C.) | (%) | Si |
| 1 | Comparative | 0.820 | 0.120 | 0.040 | 0.000 | 0.010 | 0.000 | 0.010 | 25 | 0.00 | Note |
| | example | | | | | | | | | | present |
| 2 | Comparative | 0.820 | 0.120 | 0.040 | 0.000 | 0.010 | 0.000 | 0.010 | 25 | 0.01 | Note |
| | example | | | | | | | | | | present |
| 3 | Comparative | 0.820 | 0.120 | 0.040 | 0.000 | 0.010 | 0.000 | 0.010 | 25 | 0.10 | Note |
| | example | | | | | | | | | | present |
| 4 | comparative | 0.820 | 0.120 | 0.040 | 0.000 | 0.010 | 0.000 | 0.010 | 25 | 0.25 | Note |
| | example | | | | | | | | | | present |
| 5 | Comparative | 0.820 | 0.120 | 0.040 | 0.000 | 0.010 | 0.000 | 0.010 | 25 | 0.50 | Note |
| | example | | | | | | | | | | present |
| 6 | Comparative | 0.820 | 0.120 | 0.040 | 0.000 | 0.010 | 0.000 | 0.010 | 25 | 1.00 | Note |
| | example | | | | | | | | | | present |
| 7 | Comparative | 0.820 | 0.120 | 0.040 | 0.000 | 0.010 | 0.000 | 0.010 | 100 | 0.00 | Note |
| | example | | | | | | | | | | present |
| 8 | Comparative | 0.820 | 0.120 | 0.040 | 0.000 | 0.010 | 0.000 | 0.010 | 100 | 0.01 | Note |
| | example | | | | | | | | | | present |
| 9 | Comparative | 0.820 | 0.120 | 0.040 | 0.000 | 0.010 | 0.000 | 0.010 | 100 | 0.10 | Note |
| | example | | | | | | | | | | present |
| 10 | Comparative | 0.820 | 0.120 | 0.040 | 0.000 | 0.010 | 0.000 | 0.010 | 100 | 0.25 | Note |
| | example | | | | | | | | | | present |
| 11 | Comparative | 0.820 | 0.120 | 0.040 | 0.000 | 0.010 | 0.000 | 0.010 | 100 | 0.50 | Note |
| | example | | | | | | | | | | present |
| 12 | Comparative | 0.820 | 0.120 | 0.040 | 0.000 | 0.010 | 0.000 | 0.010 | 100 | 1.00 | Note |
| | example | | | | | | | | | | present |
| 13 | Comparative | 0.820 | 0.120 | 0.040 | 0.000 | 0.010 | 0.000 | 0.010 | 250 | 0.00 | Note |
| | example | | | | | | | | | | present |
| 14 | Example | 0.820 | 0.120 | 0.040 | 0.000 | 0.010 | 0.000 | 0.010 | 250 | 0.01 | Note |
| | | | | | | | | | | | present |
| 15 | Example | 0.820 | 0.120 | 0.040 | 0.000 | 0.010 | 0.000 | 0.010 | 250 | 0.10 | Note |
| | | | | | | | | | | | present |
| 16 | Example | 0.820 | 0.120 | 0.040 | 0.000 | 0.010 | 0.000 | 0.010 | 250 | 0.25 | Note |
| | | | | | | | | | | | present |
| 17 | Example | 0.820 | 0.120 | 0.040 | 0.000 | 0.010 | 0.000 | 0.010 | 250 | 0.50 | Note |
| | | | | | | | | | | | present |
| 18 | Example | 0.820 | 0.120 | 0.040 | 0.000 | 0.010 | 0.000 | 0.010 | 250 | 1.00 | Note |
| | | | | | | | | | | | present |
| 19 | Comparative | 0.820 | 0.120 | 0.040 | 0.000 | 0.010 | 0.000 | 0.010 | 300 | 0.00 | Note |
| | example | | | | | | | | | | present |
| 20 | Example | 0.820 | 0.120 | 0.040 | 0.000 | 0.010 | 0.000 | 0.010 | 300 | 0.01 | Note |
| | | | | | | | | | | | present |
| 21 | Example | 0.820 | 0.120 | 0.040 | 0.000 | 0.010 | 0.000 | 0.010 | 300 | 0.10 | Note |
| | | | | | | | | | | | present |
| 22 | Example | 0.820 | 0.120 | 0.040 | 0.000 | 0.010 | 0.000 | 0.010 | 300 | 0.25 | Note |
| | | | | | | | | | | | present |
| 23 | Example | 0.820 | 0.120 | 0.040 | 0.000 | 0.010 | 0.000 | 0.010 | 300 | 0.50 | Note |
| | | | | | | | | | | | present |
| 24 | Example | 0.820 | 0.120 | 0.040 | 0.000 | 0.010 | 0.000 | 0.010 | 300 | 1.00 | Note |
| | | | | | | | | | | | present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 1 | Comparative | Note | <0 | 1.44 | 2.75 | 5.11 | 1.62 | 33.5 | 25.8 |
| | example | present | | | | | | | |
| 2 | Comparative | Note | <0 | 1.43 | 2.74 | 5.02 | 1.62 | 33.7 | 25.7 |
| | example | present | | | | | | | |
| 3 | Comparative | Note | <0 | 1.41 | 2.69 | 5.13 | 1.62 | 33.0 | 26.1 |
| | example | present | | | | | | | |
| 4 | comparative | Note | <0 | 1.45 | 2.74 | 5.11 | 1.62 | 33.8 | 25.9 |
| | example | present | | | | | | | |
| 5 | Comparative | Note | <0 | 1.43 | 2.71 | 5.13 | 1.62 | 33.7 | 25.8 |
| | example | present | | | | | | | |
| 6 | Comparative | Note | <0 | 1.42 | 2.72 | 5.15 | 1.61 | 33.9 | 26.0 |
| | example | present | | | | | | | |
| 7 | Comparative | Note | <0 | 1.42 | 2.75 | 5.12 | 1.62 | 33.5 | 26.1 |
| | example | present | | | | | | | |
| 8 | Comparative | Note | <0 | 1.44 | 2.73 | 5.11 | 1.62 | 33.4 | 25.9 |
| | example | present | | | | | | | |
| 9 | Comparative | Note | <0 | 1.43 | 2.75 | 5.16 | 1.62 | 33.8 | 25.8 |
| | example | present | | | | | | | |
| 10 | Comparative | Note | <0 | 1.45 | 2.74 | 5.14 | 1.62 | 33.5 | 26.2 |
| | example | present | | | | | | | |
| 11 | Comparative | Note | <0 | 1.41 | 2.72 | 5.18 | 1.61 | 33.9 | 25.9 |
| | example | present | | | | | | | |
| 12 | Comparative | Note | <0 | 1.43 | 2.73 | 5.13 | 1.61 | 33.9 | 26.0 |
| | example | present | | | | | | | |
| 13 | Comparative | Note | <0 | 1.46 | 2.77 | 5.15 | 1.62 | 33.4 | 25.8 |
| | example | present | | | | | | | |
| 14 | Example | Present | 0.2 | 1.18 | 1.56 | 2.03 | 1.62 | 33.2 | 31.1 |
| 15 | Example | Present | 0.9 | 1.08 | 1.33 | 1.62 | 1.62 | 33.5 | 33.2 |
| 16 | Example | Present | 1.5 | 1.07 | 1.31 | 1.58 | 1.62 | 33.5 | 33.7 |
| 17 | Example | Present | 2.1 | 1.07 | 1.30 | 1.59 | 1.61 | 33.6 | 33.9 |
| 18 | Example | Present | 2.4 | 1.08 | 1.32 | 1.58 | 1.61 | 33.1 | 33.8 |
| 19 | Comparative | Note | <0 | 1.41 | 2.57 | 5.11 | 1.62 | 33.1 | 26.1 |
| | example | present | | | | | | | |
| 20 | Example | Present | 0.3 | 1.18 | 1.54 | 1.95 | 1.62 | 33.0 | 31.2 |
| 21 | Example | Present | 1.3 | 1.08 | 1.31 | 1.58 | 1.62 | 33.2 | 33.4 |
| 22 | Example | Present | 1.8 | 1.07 | 1.30 | 1.57 | 1.62 | 33.0 | 33.7 |
| 23 | Example | Present | 2.5 | 1.06 | 1.31 | 1.56 | 1.62 | 33.6 | 33.8 |
| 24 | Example | Present | 2.6 | 1.07 | 1.31 | 1.58 | 1.61 | 33.6 | 33.8 |

TABLE 2A

| | | Fe₁₋(_{a+b+c+d+e+f})BₐP_{b}Si_{c}C_{d}CrₑMn_{f}, | | | | | | | | | |
|---|---|---|---|---|---|---|---|---|---|---|---|
| | Example/ | α = 0, β = 0, γ = 0 | | | | | | | Gas Heating | Gas Oxygen | |
| Sample | Comp. | Fe | B | P | Si | C | Cr | Mn | Temp. | Concentration | Oxide part |
| No | example | A | a | b | c | d | e | f | (° C.) | (%) | Si |
| 25 | Comparative | 0.830 | 0.120 | 0.040 | 0.000 | 0.010 | 0.000 | 0.00000 | 300 | 0.00 | Not |
| | example | | | | | | | | | | present |
| 26 | Comparative | 0.830 | 0.120 | 0.040 | 0.000 | 0.010 | 0.000 | 0.00000 | 300 | 0.01 | Not |
| | example | | | | | | | | | | present |
| 27 | Comparative | 0.830 | 0.120 | 0.040 | 0.000 | 0.010 | 0.000 | 0.00000 | 300 | 0.10 | Not |
| | example | | | | | | | | | | present |
| 28 | Comparative | 0.830 | 0.120 | 0.040 | 0.000 | 0.010 | 0.000 | 0.00000 | 300 | 0.25 | Not |
| | example | | | | | | | | | | present |
| 29 | Comparative | 0.830 | 0.120 | 0.040 | 0.000 | 0.010 | 0.000 | 0.00000 | 300 | 0.50 | Not |
| | example | | | | | | | | | | present |
| 30 | Comparative | 0.830 | 0.120 | 0.040 | 0.000 | 0.010 | 0.000 | 0.00000 | 300 | 1.00 | Not |
| | example | | | | | | | | | | present |
| 31 | Comparative | 0.830 | 0.120 | 0.040 | 0.000 | 0.010 | 0.000 | 0.00005 | 300 | 0.00 | Not |
| | example | | | | | | | | | | present |
| 32 | Comparative | 0.830 | 0.120 | 0.040 | 0.000 | 0.010 | 0.000 | 0.00005 | 300 | 0.01 | Not |
| | example | | | | | | | | | | present |
| 33 | Comparative | 0.830 | 0.120 | 0.040 | 0.000 | 0.010 | 0.000 | 0.00005 | 300 | 0.10 | Not |
| | example | | | | | | | | | | present |
| 34 | Example | 0.830 | 0.120 | 0.040 | 0.000 | 0.010 | 0.000 | 0.00005 | 300 | 0.25 | Not |
| | | | | | | | | | | | present |
| 35 | Example | 0.830 | 0.120 | 0.040 | 0.000 | 0.010 | 0.000 | 0.00005 | 300 | 0.50 | Not |
| | | | | | | | | | | | present |
| 36 | Example | 0.830 | 0.120 | 0.040 | 0.000 | 0.010 | 0.000 | 0.00005 | 300 | 1.00 | Not |
| | | | | | | | | | | | present |
| 37 | Comparative | 0.830 | 0.120 | 0.040 | 0.000 | 0.010 | 0.000 | 0.00010 | 300 | 0.00 | Not |
| | example | | | | | | | | | | present |
| 38 | Comparative | 0.830 | 0.120 | 0.040 | 0.000 | 0.010 | 0.000 | 0.00010 | 300 | 0.01 | Not |
| | example | | | | | | | | | | present |
| 39 | Example | 0.830 | 0.120 | 0.040 | 0.000 | 0.010 | 0.000 | 0.00010 | 300 | 0.10 | Not |
| | | | | | | | | | | | present |
| 40 | Example | 0.830 | 0.120 | 0.040 | 0.000 | 0.010 | 0.000 | 0.00010 | 300 | 0.25 | Not |
| | | | | | | | | | | | present |
| 41 | Example | 0.830 | 0.120 | 0.040 | 0.000 | 0.010 | 0.000 | 0.00010 | 300 | 0.50 | Not |
| | | | | | | | | | | | present |
| 42 | Example | 0.830 | 0.120 | 0.040 | 0.000 | 0.010 | 0.000 | 0.00010 | 300 | 1.00 | Not |
| | | | | | | | | | | | present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 25 | Comparative | Not | <0 | 1.43 | 2.73 | 5.12 | 1.65 | 33.1 | 25.5 |
| | example | present | | | | | | | |
| 26 | Comparative | Not | <0 | 1.44 | 2.78 | 5.13 | 1.65 | 33.3 | 25.7 |
| | example | present | | | | | | | |
| 27 | Comparative | Not | <0 | 1.46 | 2.75 | 5.16 | 1.65 | 33.4 | 25.4 |
| | example | present | | | | | | | |
| 28 | Comparative | Not | <0 | 1.49 | 2.74 | 5.14 | 1.65 | 34.0 | 25.5 |
| | example | present | | | | | | | |
| 29 | Comparative | Not | <0 | 1.45 | 2.80 | 5.17 | 1.65 | 33.9 | 25.8 |
| | example | present | | | | | | | |
| 30 | Comparative | Not | <0 | 1.45 | 2.77 | 5.14 | 1.64 | 33.8 | 25.6 |
| | example | present | | | | | | | |
| 31 | Comparative | Not | <0 | 1.42 | 2.68 | 5.07 | 1.65 | 33.5 | 25.9 |
| | example | present | | | | | | | |
| 32 | Comparative | Not | <0 | 1.40 | 2.66 | 5.09 | 1.65 | 33.4 | 25.9 |
| | example | present | | | | | | | |
| 33 | Comparative | Not | <0 | 1.43 | 2.67 | 5.10 | 1.65 | 33.6 | 26.0 |
| | example | present | | | | | | | |
| 34 | Example | Present | 0.1 | 1.37 | 2.31 | 3.66 | 1.64 | 33.4 | 27.9 |
| 35 | Example | Present | 0.1 | 1.35 | 2.39 | 3.57 | 1.64 | 33.2 | 28.3 |
| 36 | Example | Present | 0.1 | 1.36 | 2.34 | 3.41 | 1.64 | 33.9 | 28.4 |
| 37 | Comparative | Not | <0 | 1.42 | 2.67 | 5.09 | 1.64 | 33.7 | 25.5 |
| | example | present | | | | | | | |
| 38 | Comparative | Not | <0 | 1.41 | 2.65 | 5.05 | 1.65 | 34.0 | 26.2 |
| | example | present | | | | | | | |
| 39 | Example | Present | 0.1 | 1.36 | 2.32 | 3.59 | 1.65 | 33.5 | 28.3 |
| 40 | Example | Present | 0.1 | 1.32 | 2.20 | 3.31 | 1.64 | 33.8 | 28.8 |
| 41 | Example | Present | 0.2 | 1.20 | 1.62 | 2.19 | 1.64 | 33.0 | 30.6 |
| 42 | Example | Present | 0.3 | 1.15 | 1.63 | 1.98 | 1.63 | 33.5 | 31.2 |

TABLE 2B

| | | Fe₁₋(_{a+b+c+d+e+f})BₐP_{b}Si_{c}C_{d}CrₑMn_{f}, | | | | | | | | | |
|---|---|---|---|---|---|---|---|---|---|---|---|
| | Example/ | α = 0, β = 0, γ = 0 | | | | | | | Gas Heating | Gas Oxygen | |
| Sample | Comp. | Fe | B | P | Si | C | Cr | Mn | Temp. | Concentration | Oxide part |
| No | example | A | a | b | c | d | e | f | (° C.) | (%) | Si |
| 43 | Comparative | 0.829 | 0.120 | 0.040 | 0.000 | 0.010 | 0.000 | 0.001 | 300 | 0.00 | Not |
| | example | | | | | | | | | | present |
| 44 | Example | 0.829 | 0.120 | 0.040 | 0.000 | 0.010 | 0.000 | 0.001 | 300 | 0.01 | Not |
| | | | | | | | | | | | present |
| 45 | Example | 0.829 | 0.120 | 0.040 | 0.000 | 0.010 | 0.000 | 0.001 | 300 | 0.10 | Not |
| | | | | | | | | | | | present |
| 46 | Example | 0.829 | 0.120 | 0.040 | 0.000 | 0.010 | 0.000 | 0.001 | 300 | 0.25 | Not |
| | | | | | | | | | | | present |
| 47 | Example | 0.829 | 0.120 | 0.040 | 0.000 | 0.010 | 0.000 | 0.001 | 300 | 0.50 | Not |
| | | | | | | | | | | | present |
| 48 | Example | 0.829 | 0.120 | 0.040 | 0.000 | 0.010 | 0.000 | 0.001 | 300 | 1.00 | Not |
| | | | | | | | | | | | present |
| 49 | Comparative | 0.825 | 0.120 | 0.040 | 0.000 | 0.010 | 0.000 | 0.005 | 300 | 0.00 | Not |
| | example | | | | | | | | | | present |
| 50 | Example | 0.825 | 0.120 | 0.040 | 0.000 | 0.010 | 0.000 | 0.005 | 300 | 0.01 | Not |
| | | | | | | | | | | | present |
| 51 | Example | 0.825 | 0.120 | 0.040 | 0.000 | 0.010 | 0.000 | 0.005 | 300 | 0.10 | Not |
| | | | | | | | | | | | present |
| 52 | Example | 0.825 | 0.120 | 0.040 | 0.000 | 0.010 | 0.000 | 0.005 | 300 | 0.25 | Not |
| | | | | | | | | | | | present |
| 53 | Example | 0.825 | 0.120 | 0.040 | 0.000 | 0.010 | 0.000 | 0.005 | 300 | 0.50 | Not |
| | | | | | | | | | | | present |
| 54 | Example | 0.825 | 0.120 | 0.040 | 0.000 | 0.010 | 0.000 | 0.005 | 300 | 1.00 | Not |
| | | | | | | | | | | | present |
| 19 | Comparative | 0.820 | 0.120 | 0.040 | 0.000 | 0.010 | 0.000 | 0.010 | 300 | 0.00 | Not |
| | example | | | | | | | | | | present |
| 20 | Example | 0.820 | 0.120 | 0.040 | 0.000 | 0.010 | 0.000 | 0.010 | 300 | 0.01 | Not |
| | | | | | | | | | | | present |
| 21 | Example | 0.820 | 0.120 | 0.040 | 0.000 | 0.010 | 0.000 | 0.010 | 300 | 0.10 | Not |
| | | | | | | | | | | | present |
| 22 | Example | 0.820 | 0.120 | 0.040 | 0.000 | 0.010 | 0.000 | 0.010 | 300 | 0.25 | Not |
| | | | | | | | | | | | present |
| 23 | Example | 0.820 | 0.120 | 0.040 | 0.000 | 0.010 | 0.000 | 0.010 | 300 | 0.50 | Not |
| | | | | | | | | | | | present |
| 24 | Example | 0.820 | 0.120 | 0.040 | 0.000 | 0.010 | 0.000 | 0.010 | 300 | 1.00 | Not |
| | | | | | | | | | | | present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 43 | Comparative | Not | <0 | 1.42 | 2.66 | 5.11 | 1.64 | 33.9 | 25.9 |
| | example | present | | | | | | | |
| 44 | Example | Present | 0.1 | 1.34 | 2.36 | 3.29 | 1.64 | 33.3 | 28.6 |
| 45 | Example | Present | 0.2 | 1.21 | 1.69 | 2.08 | 1.64 | 33.6 | 30.8 |
| 46 | Example | Present | 0.3 | 1.17 | 1.61 | 2.02 | 1.64 | 33.8 | 31.3 |
| 47 | Example | Present | 0.4 | 1.14 | 1.49 | 1.79 | 1.64 | 33.1 | 32.2 |
| 48 | Example | Present | 0.4 | 1.14 | 1.47 | 1.75 | 1.63 | 33.8 | 32.3 |
| 49 | Comparative | Not | <0 | 1.42 | 2.74 | 5.08 | 1.63 | 33.6 | 26.2 |
| | example | present | | | | | | | |
| 50 | Example | Present | 0.1 | 1.33 | 2.23 | 3.18 | 1.62 | 33.7 | 28.8 |
| 51 | Example | Present | 0.5 | 1.12 | 1.43 | 1.78 | 1.63 | 33.2 | 32.6 |
| 52 | Example | Present | 0.9 | 1.08 | 1.32 | 1.56 | 1.62 | 33.3 | 33.2 |
| 53 | Example | Present | 1.2 | 1.07 | 1.30 | 1.55 | 1.62 | 33.2 | 33.5 |
| 54 | Example | Present | 1.3 | 1.08 | 1.31 | 1.54 | 1.62 | 33.6 | 33.6 |
| 19 | Comparative | Not | <0 | 1.41 | 2.57 | 5.11 | 1.62 | 33.0 | 26.1 |
| | example | present | | | | | | | |
| 20 | Example | Present | 0.3 | 1.18 | 1.54 | 1.95 | 1.62 | 33.7 | 31.2 |
| 21 | Example | Present | 1.1 | 1.08 | 1.31 | 1.58 | 1.62 | 33.6 | 33.4 |
| 22 | Example | Present | 1.8 | 1.07 | 1.30 | 1.57 | 1.62 | 33.3 | 33.7 |
| 23 | Example | Present | 2.5 | 1.06 | 1.31 | 1.56 | 1.62 | 33.2 | 33.8 |
| 24 | Example | Present | 2.6 | 1.07 | 1.31 | 1.58 | 1.61 | 33.0 | 33.8 |

TABLE 2C

| | | Fe₁₋(_{a+b+c+d+e+f})BₐP_{b}Si_{c}C_{d}CrₑMn_{f}, | | | | | | | | | |
|---|---|---|---|---|---|---|---|---|---|---|---|
| | Example/ | α = 0, β = 0, γ = 0 | | | | | | | Gas Heating | Gas Oxygen | |
| Sample | Comp. | Fe | B | P | Si | C | Cr | Mn | Temp. | Concentration | Oxide part |
| No | example | A | a | b | c | d | e | f | (° C.) | (%) | Si |
| 55 | Comparative | 0.810 | 0.120 | 0.040 | 0.000 | 0.010 | 0.000 | 0.020 | 300 | 0.00 | Note |
| | example | | | | | | | | | | present |
| 56 | Example | 0.810 | 0.120 | 0.040 | 0.000 | 0.010 | 0.000 | 0.020 | 300 | 0.01 | Note |
| | | | | | | | | | | | present |
| 57 | Example | 0.810 | 0.120 | 0.040 | 0.000 | 0.010 | 0.000 | 0.020 | 300 | 0.10 | Note |
| | | | | | | | | | | | present |
| 58 | Example | 0.810 | 0.120 | 0.040 | 0.000 | 0.010 | 0.000 | 0.020 | 300 | 0.25 | Note |
| | | | | | | | | | | | present |
| 59 | Example | 0.810 | 0.120 | 0.040 | 0.000 | 0.010 | 0.000 | 0.020 | 300 | 0.50 | Note |
| | | | | | | | | | | | present |
| 60 | Example | 0.810 | 0.120 | 0.040 | 0.000 | 0.010 | 0.000 | 0.020 | 300 | 1.00 | Note |
| | | | | | | | | | | | present |
| 61 | Comparative | 0.802 | 0.120 | 0.040 | 0.000 | 0.010 | 0.000 | 0.028 | 300 | 0.00 | Note |
| | example | | | | | | | | | | present |
| 62 | Example | 0.802 | 0.120 | 0.040 | 0.000 | 0.010 | 0.000 | 0.028 | 300 | 0.01 | Note |
| | | | | | | | | | | | present |
| 63 | Example | 0.802 | 0.120 | 0.040 | 0.000 | 0.010 | 0.000 | 0.028 | 300 | 0.10 | Note |
| | | | | | | | | | | | present |
| 64 | Example | 0.802 | 0.120 | 0.040 | 0.000 | 0.010 | 0.000 | 0.028 | 300 | 0.25 | Note |
| | | | | | | | | | | | present |
| 65 | Example | 0.802 | 0.120 | 0.040 | 0.000 | 0.010 | 0.000 | 0.028 | 300 | 0.50 | Note |
| | | | | | | | | | | | present |
| 66 | Example | 0.802 | 0.120 | 0.040 | 0.000 | 0.010 | 0.000 | 0.028 | 300 | 1.00 | Note |
| | | | | | | | | | | | present |
| 67 | Comparative | 0.800 | 0.120 | 0.040 | 0.000 | 0.010 | 0.000 | 0.030 | 300 | 0.00 | Note |
| | example | | | | | | | | | | present |
| 68 | Example | 0.800 | 0.120 | 0.040 | 0.000 | 0.010 | 0.000 | 0.030 | 300 | 0.01 | Note present |
| 69 | Example | 0.800 | 0.120 | 0.040 | 0.000 | 0.010 | 0.000 | 0.030 | 300 | 0.10 | Note |
| | | | | | | | | | | | present |
| 70 | Example | 0.800 | 0.120 | 0.040 | 0.000 | 0.010 | 0.000 | 0.030 | 300 | 0.25 | Note |
| | | | | | | | | | | | present |
| 71 | Example | 0.800 | 0.120 | 0.040 | 0.000 | 0.010 | 0.000 | 0.030 | 300 | 0.50 | Note |
| | | | | | | | | | | | present |
| 72 | Example | 0.800 | 0.120 | 0.040 | 0.000 | 0.010 | 0.000 | 0.030 | 300 | 1.00 | Note |
| | | | | | | | | | | | present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 55 | Comparative | Not | <0 | 1.43 | 2.68 | 5.12 | 1.58 | 33.7 | 26.1 |
| | example | present | | | | | | | |
| 56 | Example | Present | 0.5 | 1.13 | 1.44 | 1.75 | 1.58 | 33.9 | 32.5 |
| 57 | Example | Present | 2.3 | 1.06 | 1.32 | 1.58 | 1.58 | 33.1 | 33.9 |
| 58 | Example | Present | 3.7 | 1.05 | 1.30 | 1.56 | 1.58 | 33.0 | 33.8 |
| 59 | Example | Present | 4.7 | 1.07 | 1.31 | 1.57 | 1.57 | 33.3 | 33.8 |
| 60 | Example | Present | 5.1 | 1.04 | 1.29 | 1.54 | 1.57 | 33.5 | 34.0 |
| 61 | Comparative | Not | <0 | 1.48 | 2.76 | 5.20 | 1.56 | 33.5 | 26.3 |
| | example | present | | | | | | | |
| 62 | Example | Present | 0.7 | 1.17 | 1.54 | 2.08 | 1.56 | 33.7 | 32.9 |
| 63 | Example | Present | 3.4 | 1.12 | 1.43 | 1.83 | 1.56 | 33.2 | 33.8 |
| 64 | Example | Present | 5.3 | 1.13 | 1.44 | 1.85 | 1.56 | 33.3 | 33.9 |
| 65 | Example | Present | 6.8 | 1.12 | 1.44 | 1.85 | 1.55 | 33.6 | 34.1 |
| 66 | Example | Present | 7.1 | 1.29 | 1.95 | 2.78 | 1.55 | 33.7 | 33.9 |
| 67 | Comparative | Not | <0 | 1.58 | 2.89 | 5.34 | 1.55 | 33.3 | 26.1 |
| | example | present | | | | | | | |
| 68 | Example | Present | 0.8 | 1.32 | 2.02 | 2.87 | 1.55 | 33.8 | 32.9 |
| 69 | Example | Present | 3.5 | 1.33 | 2.05 | 2.89 | 1.55 | 33.4 | 33.5 |
| 70 | Example | Present | 5.8 | 1.33 | 2.05 | 2.91 | 1.54 | 33.4 | 33.7 |
| 71 | Example | Present | 7.2 | 1.35 | 2.11 | 3.00 | 1.54 | 33.4 | 33.8 |
| 72 | Example | Present | 7.4 | 1.34 | 2.09 | 2.99 | 1.54 | 33.2 | 33.7 |

TABLE 3

| | | Fe_{1-(a+b+c+d+e+f)}BₐP_{b}Si_{c}C_{d}CrₑMn_{f}, | | | | | | | | | |
|---|---|---|---|---|---|---|---|---|---|---|---|
| | Example/ | α = 0, β = 0, γ = 0 | | | | | | | Gas Heating | Gas Oxygen | |
| Sample | Comp. | Fe | B | P | Si | C | Cr | Mn | Temp. | Concentration | Oxide part |
| No | example | A | a | b | c | d | e | f | (° C.) | (%) | Si |
| 25 | Comparative | 0.830 | 0.120 | 0.040 | 0.000 | 0.010 | 0.000 | 0.00000 | 300 | 0.00 | Not |
| | example | | | | | | | | | | present |
| 26 | Comparative | 0.830 | 0.120 | 0.040 | 0.000 | 0.010 | 0.000 | 0.00000 | 300 | 0.01 | Not |
| | example | | | | | | | | | | present |
| 27 | Comparative | 0.830 | 0.120 | 0.040 | 0.000 | 0.010 | 0.000 | 0.00000 | 300 | 0.10 | Not |
| | example | | | | | | | | | | present |
| 28 | Comparative | 0.830 | 0.120 | 0.040 | 0.000 | 0.010 | 0.000 | 0.00000 | 300 | 0.25 | Not |
| | example | | | | | | | | | | present |
| 29 | Comparative | 0.830 | 0.120 | 0.040 | 0.000 | 0.010 | 0.000 | 0.00000 | 300 | 0.50 | Not |
| | example | | | | | | | | | | present |
| 30 | Comparative | 0.830 | 0.120 | 0.040 | 0.000 | 0.010 | 0.000 | 0.00000 | 300 | 1.00 | Not |
| | example | | | | | | | | | | present |
| 19 | Comparative | 0.820 | 0.120 | 0.040 | 0.000 | 0.010 | 0.000 | 0.010 | 300 | 0.00 | Not |
| | example | | | | | | | | | | present |
| 20 | Example | 0.820 | 0.120 | 0.040 | 0.000 | 0.010 | 0.000 | 0.010 | 300 | 0.01 | Not |
| | | | | | | | | | | | present |
| 21 | Example | 0.820 | 0.120 | 0.040 | 0.000 | 0.010 | 0.000 | 0.010 | 300 | 0.10 | Not |
| | | | | | | | | | | | present |
| 22 | Example | 0.820 | 0.120 | 0.040 | 0.000 | 0.010 | 0.000 | 0.010 | 300 | 0.25 | Not |
| | | | | | | | | | | | present |
| 23 | Example | 0.820 | 0.120 | 0.040 | 0.000 | 0.010 | 0.000 | 0.010 | 300 | 0.50 | Not |
| | | | | | | | | | | | present |
| 24 | Example | 0.820 | 0.120 | 0.040 | 0.000 | 0.010 | 0.000 | 0.010 | 300 | 1.00 | Not |
| | | | | | | | | | | | present |
| 73 | Comparative | 0.810 | 0.120 | 0.040 | 0.020 | 0.010 | 0.000 | 0.00000 | 300 | 0.00 | Present |
| | example | | | | | | | | | | |
| 74 | Comparative | 0.810 | 0.120 | 0.040 | 0.020 | 0.010 | 0.000 | 0.00000 | 300 | 0.01 | Present |
| | example | | | | | | | | | | |
| 75 | Comparative | 0.810 | 0.120 | 0.040 | 0.020 | 0.010 | 0.000 | 0.00000 | 300 | 0.10 | Present |
| | example | | | | | | | | | | |
| 76 | Comparative | 0.810 | 0.120 | 0.040 | 0.020 | 0.010 | 0.000 | 0.00000 | 300 | 0.25 | Present |
| | example | | | | | | | | | | |
| 77 | Comparative | 0.810 | 0.120 | 0.040 | 0.020 | 0.010 | 0.000 | 0.00000 | 300 | 0.50 | Present |
| | example | | | | | | | | | | |
| 78 | Comparative | 0.810 | 0.120 | 0.040 | 0.020 | 0.010 | 0.000 | 0.00000 | 300 | 1.00 | Present |
| | example | | | | | | | | | | |
| 79 | Comparative | 0.800 | 0.120 | 0.040 | 0.020 | 0.010 | 0.000 | 0.010 | 300 | 0.00 | Present |
| | example | | | | | | | | | | |
| 80 | Example | 0.800 | 0.120 | 0.040 | 0.020 | 0.010 | 0.000 | 0.010 | 300 | 0.01 | Present |
| 81 | Example | 0.800 | 0.120 | 0.040 | 0.020 | 0.010 | 0.000 | 0.010 | 300 | 0.10 | Present |
| 82 | Example | 0.800 | 0.120 | 0.040 | 0.020 | 0.010 | 0.000 | 0.010 | 300 | 0.25 | Present |
| 83 | Example | 0.800 | 0.120 | 0.040 | 0.020 | 0.010 | 0.000 | 0.010 | 300 | 0.50 | Present |
| 84 | Example | 0.800 | 0.120 | 0.040 | 0.020 | 0.010 | 0.000 | 0.010 | 300 | 1.00 | Present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 25 | Comparative | Not | <0 | 1.43 | 2.73 | 5.12 | 1.65 | 33.8 | 25.5 |
| | example | present | | | | | | | |
| 26 | Comparative | Not | <0 | 1.44 | 2.78 | 5.13 | 1.65 | 33.3 | 25.7 |
| | example | present | | | | | | | |
| 27 | Comparative | Not | <0 | 1.46 | 2.75 | 5.16 | 1.65 | 33.9 | 25.4 |
| | example | present | | | | | | | |
| 28 | Comparative | Not | <0 | 1.49 | 2.74 | 5.14 | 1.65 | 33.6 | 25.5 |
| | example | present | | | | | | | |
| 29 | Comparative | Not | <0 | 1.45 | 2.80 | 5.17 | 1.65 | 33.2 | 25.8 |
| | example | present | | | | | | | |
| 30 | Comparative | Not | <0 | 1.45 | 2.77 | 5.14 | 1.64 | 33.0 | 25.6 |
| | example | present | | | | | | | |
| 19 | Comparative | Not | <0 | 1.41 | 2.57 | 5.11 | 1.62 | 33.2 | 26.1 |
| | example | present | | | | | | | |
| 20 | Example | Present | 0.3 | 1.18 | 1.54 | 1.95 | 1.62 | 34.0 | 31.2 |
| 21 | Example | Present | 1.1 | 1.08 | 1.31 | 1.58 | 1.62 | 33.9 | 33.4 |
| 22 | Example | Present | 1.8 | 1.07 | 1.30 | 1.57 | 1.62 | 33.3 | 33.7 |
| 23 | Example | Present | 2.5 | 1.06 | 1.31 | 1.56 | 1.62 | 34.0 | 33.8 |
| 24 | Example | Present | 2.6 | 1.07 | 1.31 | 1.58 | 1.61 | 33.7 | 33.8 |
| 73 | Comparative | Not | <0 | 1.45 | 2.76 | 5.12 | 1.57 | 33.0 | 25.6 |
| | example | present | | | | | | | |
| 74 | Comparative | Not | <0 | 1.43 | 2.76 | 5.37 | 1.57 | 33.7 | 25.8 |
| | example | present | | | | | | | |
| 75 | Comparative | Not | <0 | 1.45 | 2.78 | 5.14 | 1.57 | 33.0 | 25.7 |
| | example | present | | | | | | | |
| 76 | Comparative | Not | <0 | 1.46 | 2.75 | 5.15 | 1.57 | 33.8 | 25.6 |
| | example | present | | | | | | | |
| 77 | Comparative | Not | <0 | 1.44 | 2.76 | 5.17 | 1.57 | 33.7 | 25.9 |
| | example | present | | | | | | | |
| 78 | Comparative | Not | <0 | 1.46 | 2.79 | 5.13 | 1.56 | 33.3 | 25.6 |
| | example | present | | | | | | | |
| 79 | Comparative | Not | <0 | 1.43 | 2.52 | 5.14 | 1.53 | 33.1 | 26.4 |
| | example | present | | | | | | | |
| 80 | Example | Present | 0.3 | 1.17 | 1.55 | 1.97 | 1.53 | 33.7 | 35.4 |
| 81 | Example | Present | 1.0 | 1.07 | 1.33 | 1.55 | 1.53 | 33.5 | 35.8 |
| 82 | Example | Present | 1.7 | 1.06 | 1.32 | 1.58 | 1.53 | 33.8 | 36.2 |
| 83 | Example | Present | 2.6 | 1.06 | 1.31 | 1.56 | 1.52 | 33.1 | 36.3 |
| 84 | Example | Present | 2.7 | 1.07 | 1.33 | 1.58 | 1.52 | 33.4 | 36.5 |

TABLE 4

| | | Fe_{1-(a+b+c+d+e+f)}BₐP_{b}Si_{c}C_{d}CrₑMn_{f}, | | | | | | | | | |
|---|---|---|---|---|---|---|---|---|---|---|---|
| | Example/ | α = 0, β = 0, γ = 0 | | | | | | | Gas Heating | Gas Oxygen | |
| Sample | Comp. | Fe | B | P | Si | C | Cr | Mn | Temp. | Concentration | Oxide part |
| No | example | A | a | b | c | d | e | f | (° C.) | (%) | Si |
| 22 | Example | 0.820 | 0.120 | 0.040 | 0.000 | 0.010 | 0.000 | 0.010 | 300 | 0.25 | Not |
| | | | | | | | | | | | present |
| 85 | Example | 0.810 | 0.120 | 0.040 | 0.010 | 0.010 | 0.000 | 0.010 | 300 | 0.25 | Present |
| 82 | Example | 0.800 | 0.120 | 0.040 | 0.020 | 0.010 | 0.000 | 0.010 | 300 | 0.25 | Present |
| 86 | Example | 0.790 | 0.120 | 0.040 | 0.030 | 0.010 | 0.000 | 0.010 | 300 | 0.25 | Present |
| 87 | Example | 0.770 | 0.120 | 0.040 | 0.050 | 0.010 | 0.000 | 0.010 | 300 | 0.25 | Present |
| 88 | Example | 0.750 | 0.120 | 0.040 | 0.070 | 0.010 | 0.000 | 0.010 | 300 | 0.25 | Present |
| 89 | Example | 0.730 | 0.120 | 0.040 | 0.090 | 0.010 | 0.000 | 0.010 | 300 | 0.25 | Present |
| 90 | Example | 0.720 | 0.120 | 0.040 | 0.100 | 0.010 | 0.000 | 0.010 | 300 | 0.25 | Present |
| 91 | Example | 0.710 | 0.120 | 0.040 | 0.110 | 0.010 | 0.000 | 0.010 | 300 | 0.25 | Present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 22 | Example | Present | 1.8 | 1.07 | 1.30 | 1.57 | 1.61 | 33.4 | 33.7 |
| 85 | Example | Present | 1.7 | 1.06 | 1.31 | 1.59 | 1.57 | 33.6 | 35.7 |
| 82 | Example | Present | 1.7 | 1.06 | 1.32 | 1.58 | 1.53 | 33.7 | 36.2 |
| 86 | Example | Present | 1.9 | 1.05 | 1.33 | 1.57 | 1.49 | 33.1 | 36.6 |
| 87 | Example | Present | 1.8 | 1.07 | 1.35 | 1.61 | 1.46 | 33.1 | 36.7 |
| 88 | Example | Present | 1.6 | 1.06 | 1.34 | 1.57 | 1.42 | 33.6 | 36.9 |
| 89 | Example | Present | 1.7 | 1.04 | 1.29 | 1.53 | 1.38 | 33.5 | 37.1 |
| 90 | Example | Present | 1.9 | 1.04 | 1.28 | 1.52 | 1.33 | 33.8 | 37.0 |
| 91 | Example | Present | 1.8 | 1.03 | 1.29 | 1.49 | 1.29 | 34.0 | 36.9 |

TABLE 5A

| | | Fe_{1-(a+b+c+d+e+f)}BₐP_{b}Si_{c}C_{d}CrₑMn_{f}, | | | | | | | | | |
|---|---|---|---|---|---|---|---|---|---|---|---|
| | Example/ | α = 0, β = 0, γ = 0 | | | | | | | Gas Heating | Gas Oxygen | |
| Sample | Comp. | Fe | B | P | Si | C | Cr | Mn | Temp. | Concentration | Oxide part |
| No | example | A | a | b | c | d | e | f | (° C.) | (%) | Si |
| 92 | Example | 0.910 | 0.010 | 0.030 | 0.020 | 0.010 | 0.010 | 0.010 | 300 | 0.25 | Present |
| 93 | Example | 0.900 | 0.020 | 0.030 | 0.020 | 0.010 | 0.010 | 0.010 | 300 | 0.25 | Present |
| 94 | Example | 0.890 | 0.030 | 0.030 | 0.020 | 0.010 | 0.010 | 0.010 | 300 | 0.25 | Present |
| 95 | Example | 0.830 | 0.090 | 0.030 | 0.020 | 0.010 | 0.010 | 0.010 | 300 | 0.25 | Present |
| 96 | Example | 0.810 | 0.110 | 0.030 | 0.020 | 0.010 | 0.010 | 0.010 | 300 | 0.25 | Present |
| 97 | Example | 0.800 | 0.120 | 0.030 | 0.020 | 0.010 | 0.010 | 0.010 | 300 | 0.25 | Present |
| 98 | Example | 0.790 | 0.130 | 0.030 | 0.020 | 0.010 | 0.010 | 0.010 | 300 | 0.25 | Present |
| 99 | Example | 0.780 | 0.140 | 0.030 | 0.020 | 0.010 | 0.010 | 0.010 | 300 | 0.25 | Present |
| 100 | Example | 0.770 | 0.150 | 0.030 | 0.020 | 0.010 | 0.010 | 0.010 | 300 | 0.25 | Present |
| 101 | Example | 0.730 | 0.190 | 0.030 | 0.020 | 0.010 | 0.010 | 0.010 | 300 | 0.25 | Present |
| 102 | Example | 0.720 | 0.200 | 0.030 | 0.020 | 0.010 | 0.010 | 0.010 | 300 | 0.25 | Present |
| 103 | Example | 0.710 | 0.210 | 0.030 | 0.020 | 0.010 | 0.010 | 0.010 | 300 | 0.25 | Present |
| 104 | Example | 0.830 | 0.120 | 0.000 | 0.020 | 0.010 | 0.010 | 0.010 | 300 | 0.25 | Present |
| 105 | Example | 0.820 | 0.120 | 0.010 | 0.020 | 0.010 | 0.010 | 0.010 | 300 | 0.25 | Present |
| 97 | Example | 0.800 | 0.120 | 0.030 | 0.020 | 0.010 | 0.010 | 0.010 | 300 | 0.25 | Present |
| 106 | Example | 0.790 | 0.120 | 0.040 | 0.020 | 0.010 | 0.010 | 0.010 | 300 | 0.25 | Present |
| 107 | Example | 0.780 | 0.120 | 0.050 | 0.020 | 0.010 | 0.010 | 0.010 | 300 | 0.25 | Present |
| 108 | Example | 0.770 | 0.120 | 0.060 | 0.020 | 0.010 | 0.010 | 0.010 | 300 | 0.25 | Present |
| 109 | Example | 0.760 | 0.120 | 0.070 | 0.020 | 0.010 | 0.010 | 0.010 | 300 | 0.25 | Present |
| 110 | Example | 0.750 | 0.120 | 0.080 | 0.020 | 0.010 | 0.010 | 0.010 | 300 | 0.25 | Present |
| 111 | Example | 0.820 | 0.120 | 0.030 | 0.000 | 0.010 | 0.010 | 0.010 | 300 | 0.25 | Not |
| | | | | | | | | | | | present |
| 112 | Example | 0.810 | 0.120 | 0.030 | 0.010 | 0.010 | 0.010 | 0.010 | 300 | 0.25 | Present |
| 97 | Example | 0.800 | 0.120 | 0.030 | 0.020 | 0.010 | 0.010 | 0.010 | 300 | 0.25 | Present |
| 113 | Example | 0.790 | 0.120 | 0.030 | 0.030 | 0.010 | 0.010 | 0.010 | 300 | 0.25 | Present |
| 114 | Example | 0.770 | 0.120 | 0.030 | 0.050 | 0.010 | 0.010 | 0.010 | 300 | 0.25 | Present |
| 115 | Example | 0.750 | 0.120 | 0.030 | 0.070 | 0.010 | 0.010 | 0.010 | 300 | 0.25 | Present |
| 116 | Example | 0.730 | 0.120 | 0.030 | 0.090 | 0.010 | 0.010 | 0.010 | 300 | 0.25 | Present |
| 117 | Example | 0.720 | 0.120 | 0.030 | 0.100 | 0.010 | 0.010 | 0.010 | 300 | 0.25 | Present |
| 118 | Example | 0.710 | 0.120 | 0.030 | 0.110 | 0.010 | 0.010 | 0.010 | 300 | 0.25 | Present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 92 | Example | Present | 1.7 | 1.42 | 1.98 | 3.03 | 1.73 | 33.8 | 33.4 |
| 93 | Example | Present | 1.8 | 1.32 | 1.71 | 2.23 | 1.71 | 33.4 | 35.3 |
| 94 | Example | Present | 1.7 | 1.21 | 1.59 | 2.07 | 1.69 | 33.3 | 36.2 |
| 95 | Example | Present | 1.9 | 1.08 | 1.35 | 1.62 | 1.57 | 34.0 | 36.8 |
| 96 | Example | Present | 1.9 | 1.06 | 1.31 | 1.58 | 1.54 | 33.9 | 36.7 |
| 97 | Example | Present | 1.6 | 1.06 | 1.29 | 1.56 | 1.51 | 33.1 | 36.6 |
| 98 | Example | Present | 1.7 | 1.07 | 1.31 | 1.59 | 1.49 | 33.4 | 36.5 |
| 99 | Example | Present | 1.9 | 1.06 | 1.33 | 1.58 | 1.46 | 33.4 | 36.7 |
| 100 | Example | Present | 1.9 | 1.05 | 1.35 | 1.57 | 1.44 | 33.3 | 36.8 |
| 101 | Example | Present | 2.0 | 1.07 | 1.32 | 1.59 | 1.34 | 33.3 | 36.6 |
| 102 | Example | Present | 1.7 | 1.09 | 1.35 | 1.61 | 1.32 | 33.1 | 36.9 |
| 103 | Example | Present | 1.7 | 1.10 | 1.37 | 1.63 | 1.28 | 33.2 | 36.7 |
| 104 | Example | Present | 1.8 | 1.10 | 1.39 | 1.69 | 1.68 | 34.0 | 36.8 |
| 105 | Example | Present | 1.7 | 1.10 | 1.38 | 1.67 | 1.62 | 33.4 | 36.7 |
| 97 | Example | Present | 1.7 | 1.06 | 1.31 | 1.58 | 1.51 | 33.3 | 36.6 |
| 106 | Example | Present | 1.8 | 1.05 | 1.30 | 1.55 | 1.46 | 33.0 | 36.8 |
| 107 | Example | Present | 1.6 | 1.06 | 1.33 | 1.59 | 1.42 | 33.4 | 36.7 |
| 108 | Example | Present | 1.9 | 1.05 | 1.31 | 1.57 | 1.36 | 33.1 | 36.9 |
| 109 | Example | Present | 1.9 | 1.05 | 1.29 | 1.52 | 1.31 | 33.4 | 36.7 |
| 110 | Example | Present | 1.9 | 1.05 | 1.28 | 1.48 | 1.25 | 33.3 | 36.8 |
| 111 | Example | Present | 1.8 | 1.05 | 1.33 | 1.59 | 1.58 | 33.5 | 33.7 |
| 112 | Example | Present | 1.9 | 1.06 | 1.32 | 1.60 | 1.55 | 33.1 | 35.8 |
| 97 | Example | Present | 1.9 | 1.06 | 1.31 | 1.58 | 1.51 | 33.9 | 36.6 |
| 113 | Example | Present | 1.8 | 1.05 | 1.32 | 1.61 | 1.48 | 33.0 | 36.9 |
| 114 | Example | Present | 1.7 | 1.04 | 1.29 | 1.54 | 1.43 | 33.9 | 37.1 |
| 115 | Example | Present | 2.0 | 1.04 | 1.29 | 1.53 | 1.38 | 33.5 | 37.1 |
| 116 | Example | Present | 1.7 | 1.03 | 1.28 | 1.51 | 1.35 | 33.6 | 37.0 |
| 117 | Example | Present | 1.7 | 1.04 | 1.28 | 1.47 | 1.32 | 33.6 | 36.9 |
| 118 | Example | Present | 1.9 | 1.05 | 1.25 | 1.45 | 1.28 | 33.7 | 37.1 |

TABLE 5B

| | | Fe_{1-(a+b+c+d+e+f)}BₐP_{b}Si_{c}C_{d}CrₑMn_{f}, | | | | | | | | | |
|---|---|---|---|---|---|---|---|---|---|---|---|
| | Example/ | α = 0, β = 0, γ = 0 | | | | | | | Gas Heating | Gas Oxygen | |
| Sample | Comp. | Fe | B | P | Si | C | Cr | Mn | Temp. | Concentration | Oxide part |
| No | example | A | a | b | c | d | e | f | (° C.) | (%) | Si |
| 119 | Example | 0.810 | 0.120 | 0.030 | 0.020 | 0.000 | 0.010 | 0.010 | 300 | 0.25 | Present |
| 97 | Example | 0.800 | 0.120 | 0.030 | 0.020 | 0.010 | 0.010 | 0.010 | 300 | 0.25 | Present |
| 120 | Example | 0.790 | 0.120 | 0.030 | 0.020 | 0.020 | 0.010 | 0.010 | 300 | 0.25 | Present |
| 121 | Example | 0.780 | 0.120 | 0.030 | 0.020 | 0.030 | 0.010 | 0.010 | 300 | 0.25 | Present |
| 122 | Example | 0.770 | 0.120 | 0.030 | 0.020 | 0.040 | 0.010 | 0.010 | 300 | 0.25 | Present |
| 123 | Example | 0.760 | 0.120 | 0.030 | 0.020 | 0.050 | 0.010 | 0.010 | 300 | 0.25 | Present |
| 124 | Example | 0.750 | 0.120 | 0.030 | 0.020 | 0.060 | 0.010 | 0.010 | 300 | 0.25 | Present |
| 125 | Example | 0.810 | 0.120 | 0.030 | 0.020 | 0.010 | 0.000 | 0.010 | 300 | 0.25 | Present |
| 97 | Example | 0.800 | 0.120 | 0.030 | 0.020 | 0.010 | 0.010 | 0.010 | 300 | 0.25 | Present |
| 126 | Example | 0.790 | 0.120 | 0.030 | 0.020 | 0.010 | 0.020 | 0.010 | 300 | 0.25 | Present |
| 127 | Example | 0.780 | 0.120 | 0.030 | 0.020 | 0.010 | 0.030 | 0.010 | 300 | 0.25 | Present |
| 128 | Example | 0.770 | 0.120 | 0.030 | 0.020 | 0.010 | 0.040 | 0.010 | 300 | 0.25 | Present |
| 129 | Example | 0.760 | 0.120 | 0.030 | 0.020 | 0.010 | 0.050 | 0.010 | 300 | 0.25 | Present |
| 130 | Comparative | 0.820 | 0.120 | 0.030 | 0.020 | 0.010 | 0.000 | 0.00000 | 300 | 0.25 | Present |
| | example | | | | | | | | | | |
| 97 | Example | 0.800 | 0.120 | 0.030 | 0.020 | 0.010 | 0.010 | 0.010 | 300 | 0.25 | Present |
| 131 | Example | 0.780 | 0.120 | 0.030 | 0.020 | 0.010 | 0.020 | 0.020 | 300 | 0.25 | Present |
| 132 | Example | 0.762 | 0.120 | 0.030 | 0.020 | 0.010 | 0.030 | 0.028 | 300 | 0.25 | Present |
| 133 | Example | 0.750 | 0.120 | 0.030 | 0.020 | 0.010 | 0.040 | 0.030 | 300 | 0.25 | Present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 119 | Example | Present | 1.8 | 1.05 | 1.33 | 1.59 | 1.54 | 33.6 | 36.2 |
| 97 | Example | Present | 1.8 | 1.06 | 1.31 | 1.58 | 1.51 | 33.4 | 36.6 |
| 120 | Example | Present | 1.7 | 1.07 | 1.32 | 1.60 | 1.49 | 33.6 | 36.7 |
| 121 | Example | Present | 1.6 | 1.09 | 1.35 | 1.62 | 1.45 | 33.0 | 36.5 |
| 122 | Example | Present | 1.8 | 1.13 | 1.41 | 1.72 | 1.42 | 33.7 | 36.9 |
| 123 | Example | Present | 1.9 | 1.23 | 1.59 | 2.07 | 1.39 | 33.9 | 36.3 |
| 124 | Example | Present | 1.7 | 1.32 | 1.89 | 2.75 | 1.35 | 33.3 | 35.9 |
| 125 | Example | Present | 1.8 | 1.05 | 1.33 | 1.58 | 1.58 | 33.2 | 36.5 |
| 97 | Example | Present | 1.9 | 1.06 | 1.31 | 1.58 | 1.51 | 34.0 | 36.6 |
| 126 | Example | Present | 1.8 | 1.04 | 1.31 | 1.53 | 1.45 | 33.7 | 36.8 |
| 127 | Example | Present | 1.7 | 1.05 | 1.32 | 1.57 | 1.39 | 33.1 | 36.6 |
| 128 | Example | Present | 1.6 | 1.06 | 1.35 | 1.60 | 1.33 | 33.9 | 36.7 |
| 129 | Example | Present | 1.8 | 1.04 | 1.34 | 1.59 | 1.26 | 33.5 | 36.5 |
| 130 | Comparative | Not | <0 | 1.45 | 2.71 | 5.15 | 1.54 | 33.4 | 28.7 |
| | example | present | | | | | | | |
| 97 | Example | Present | 1.8 | 1.06 | 1.31 | 1.58 | 1.51 | 33.1 | 36.6 |
| 131 | Example | Present | 3.6 | 1.05 | 1.32 | 1.56 | 1.47 | 33.7 | 36.7 |
| 132 | Example | Present | 5.3 | 1.14 | 1.43 | 1.82 | 1.42 | 33.9 | 36.9 |
| 133 | Example | Present | 5.8 | 1.33 | 2.11 | 2.95 | 1.39 | 33.6 | 36.5 |

TABLE 6

| | | (Fe_{1-α}Co_{α})_{1-(a+b+c+d+e+f)}BₐP_{b}Si_{c}C_{d}CrₑMn_{f}, | | | | | | | | | |
|---|---|---|---|---|---|---|---|---|---|---|---|
| | Example/ | β = 0, γ = 0 | | | | | | | | Gas | Gas Oxygen |
| Sample | Comp. | Fe + Co | Co/(Fe + Co) | B | P | Si | C | Cr | Mn | Heating Temp. | Concentration |
| No | example | A | α | a | b | c | d | e | f | (° C.) | (%) |
| 97 | Example | 0.800 | 0.000 | 0.120 | 0.030 | 0.020 | 0.010 | 0.010 | 0.010 | 300 | 0.25 |
| 134 | Example | 0.800 | 0.005 | 0.120 | 0.030 | 0.020 | 0.010 | 0.010 | 0.010 | 300 | 0.25 |
| 135 | Example | 0.800 | 0.010 | 0.120 | 0.030 | 0.020 | 0.010 | 0.010 | 0.010 | 300 | 0.25 |
| 136 | Example | 0.800 | 0.030 | 0.120 | 0.030 | 0.020 | 0.010 | 0.010 | 0.010 | 300 | 0.25 |
| 137 | Example | 0.800 | 0.050 | 0.120 | 0.030 | 0.020 | 0.010 | 0.010 | 0.010 | 300 | 0.25 |
| 138 | Example | 0.800 | 0.150 | 0.120 | 0.030 | 0.020 | 0.010 | 0.010 | 0.010 | 300 | 0.25 |
| 139 | Example | 0.800 | 0.300 | 0.120 | 0.030 | 0.020 | 0.010 | 0.010 | 0.010 | 300 | 0.25 |
| 140 | Example | 0.800 | 0.450 | 0.120 | 0.030 | 0.020 | 0.010 | 0.010 | 0.010 | 300 | 0.25 |
| 141 | Example | 0.800 | 0.500 | 0.120 | 0.030 | 0.020 | 0.010 | 0.010 | 0.010 | 300 | 0.25 |
| 142 | Example | 0.800 | 0.600 | 0.120 | 0.030 | 0.020 | 0.010 | 0.010 | 0.010 | 300 | 0.25 |
| 143 | Example | 0.800 | 0.700 | 0.120 | 0.030 | 0.020 | 0.010 | 0.010 | 0.010 | 300 | 0.25 |
| 144 | Example | 0.800 | 0.800 | 0.120 | 0.030 | 0.020 | 0.010 | 0.010 | 0.010 | 300 | 0.25 |

| | Example/ | | | | Coercivity | | | | Core | |
|---|---|---|---|---|---|---|---|---|---|---|
| Sample | Comp. | Oxide part | Max | [Mn]o − [Mn]m | (Oe) | | | σ s | Relative | Core |
| No | example | Si | Mn | (at %) | Hc1 | Hc2 | Hc3 | (T) | Permeability | Q value |
| 97 | Example | Present | Present | 1.7 | 1.06 | 1.29 | 1.56 | 1.51 | 33.5 | 36.6 |
| 134 | Example | Present | Present | 1.7 | 1.05 | 1.31 | 1.57 | 1.55 | 33.4 | 36.8 |
| 135 | Example | Present | Present | 1.9 | 1.06 | 1.33 | 1.55 | 1.56 | 33.8 | 36.7 |
| 136 | Example | Present | Present | 1.6 | 1.05 | 1.32 | 1.54 | 1.58 | 33.8 | 36.5 |
| 137 | Example | Present | Present | 1.7 | 1.07 | 1.35 | 1.57 | 1.59 | 33.9 | 36.7 |
| 138 | Example | Present | Present | 1.8 | 1.05 | 1.34 | 1.56 | 1.61 | 33.5 | 36.8 |
| 139 | Example | Present | Present | 1.7 | 1.04 | 1.33 | 1.55 | 1.62 | 33.9 | 36.5 |
| 140 | Example | Present | Present | 1.7 | 1.06 | 1.31 | 1.56 | 1.61 | 33.4 | 36.8 |
| 141 | Example | Present | Present | 1.9 | 1.05 | 1.32 | 1.54 | 1.60 | 33.7 | 35.7 |
| 142 | Example | Present | Present | 2.0 | 1.06 | 1.35 | 1.55 | 1.58 | 33.4 | 36.8 |
| 143 | Example | Present | Present | 1.8 | 1.07 | 1.34 | 1.57 | 1.52 | 33.1 | 36.6 |
| 144 | Example | Present | Present | 1.9 | 1.03 | 1.35 | 1.58 | 1.48 | 33.5 | 36.7 |

TABLE 8

| | | (Fe_{1-β}Ni_{β})_{1-(a+b+c+d+e+f)}BₐP_{b}Si_{c}C_{d}CrₑMn_{f}, | | | | | | | | | |
|---|---|---|---|---|---|---|---|---|---|---|---|
| | Example/ | α = 0, γ = 0 | | | | | | | | Gas | Gas Oxygen |
| Sample | Comp. | Fe + Ni | Ni/(Fe + Ni) | B | P | Si | C | Cr | Mn | Heating Temp. | Concentration |
| No | example | A | β | a | b | c | d | e | f | (° C.) | (%) |
| 97 | Example | 0.800 | 0.000 | 0.120 | 0.030 | 0.020 | 0.010 | 0.010 | 0.010 | 300 | 0.25 |
| 145 | Example | 0.800 | 0.005 | 0.120 | 0.030 | 0.020 | 0.010 | 0.010 | 0.010 | 300 | 0.25 |
| 146 | Example | 0.800 | 0.010 | 0.120 | 0.030 | 0.020 | 0.010 | 0.010 | 0.010 | 300 | 0.25 |
| 147 | Example | 0.800 | 0.050 | 0.120 | 0.030 | 0.020 | 0.010 | 0.010 | 0.010 | 300 | 0.25 |
| 148 | Example | 0.800 | 0.100 | 0.120 | 0.030 | 0.020 | 0.010 | 0.010 | 0.010 | 300 | 0.25 |
| 149 | Example | 0.800 | 0.150 | 0.120 | 0.030 | 0.020 | 0.010 | 0.010 | 0.010 | 300 | 0.25 |
| 150 | Example | 0.800 | 0.200 | 0.120 | 0.030 | 0.020 | 0.010 | 0.010 | 0.010 | 300 | 0.25 |
| 151 | Example | 0.800 | 0.250 | 0.120 | 0.030 | 0.020 | 0.010 | 0.010 | 0.010 | 300 | 0.25 |

| | Example/ | | | | Coercivity | | | | Core | |
|---|---|---|---|---|---|---|---|---|---|---|
| Sample | Comp. | Oxide part | Max | [Mn]o − [Mn]m | (Oe) | | | σ s | Relative | Core |
| No | example | Si | Mn | (at %) | Hc1 | Hc2 | Hc3 | (T) | Permeability | Q value |
| 97 | Example | Present | Present | 1.7 | 1.06 | 1.29 | 1.56 | 1.51 | 33.8 | 36.6 |
| 145 | Example | Present | Present | 1.9 | 1.05 | 1.31 | 1.58 | 1.52 | 33.7 | 36.5 |
| 146 | Example | Present | Present | 1.8 | 1.07 | 1.32 | 1.59 | 1.51 | 33.4 | 36.7 |
| 147 | Example | Present | Present | 1.8 | 1.06 | 1.33 | 1.57 | 1.47 | 34.0 | 36.5 |
| 148 | Example | Present | Present | 1.6 | 1.05 | 1.35 | 1.56 | 1.42 | 33.8 | 36.7 |
| 149 | Example | Present | Present | 1.7 | 1.06 | 1.32 | 1.57 | 1.38 | 33.3 | 36.8 |
| 150 | Example | Present | Present | 1.8 | 1.07 | 1.33 | 1.58 | 1.34 | 33.0 | 36.7 |
| 151 | Example | Present | Present | 1.8 | 1.08 | 1.34 | 1.59 | 1.28 | 33.1 | 36.5 |

TABLE 8A

| | Example/ | (Fe_{1-γ}X1_{γ})_{0.800}B_{0.120}P_{0.030}Si_{0.020}C_{0.010}Cr_{0.010}Mn_{0.010}, | | Gas | Gas Oxygen | Oxide |
|---|---|---|---|---|---|---|
| Sample | Comp. | α = 0, β = 0 | | Heating Temp. | Concentration | part |
| No | example | X1 | γ | (° C.) | (%) | Si |
| 97 | Example | — | 0.000 | 300 | 0.25 | Present |
| 152 | Example | Al | 0.001 | 300 | 0.25 | Present |
| 153 | Example | Al | 0.003 | 300 | 0.25 | Present |
| 154 | Example | Al | 0.010 | 300 | 0.25 | Present |
| 155 | Example | Al | 0.025 | 300 | 0.25 | Present |
| 156 | Example | Zn | 0.001 | 300 | 0.25 | Present |
| 157 | Example | Zn | 0.003 | 300 | 0.25 | Present |
| 158 | Example | Zn | 0.010 | 300 | 0.25 | Present |
| 159 | Example | Zn | 0.025 | 300 | 0.25 | Present |
| 160 | Example | Sn | 0.001 | 300 | 0.25 | Present |
| 161 | Example | Sn | 0.003 | 300 | 0.25 | Present |
| 162 | Example | Sn | 0.010 | 300 | 0.25 | Present |
| 163 | Example | Sn | 0.025 | 300 | 0.25 | Present |
| 164 | Example | Cu | 0.001 | 300 | 0.25 | Present |
| 165 | Example | Cu | 0.003 | 300 | 0.25 | Present |
| 166 | Example | Cu | 0.010 | 300 | 0.25 | Present |
| 167 | Example | Cu | 0.025 | 300 | 0.25 | Present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 97 | Example | Present | 1.7 | 1.06 | 1.29 | 1.56 | 1.51 | 33.5 | 36.6 |
| 152 | Example | Present | 1.9 | 1.05 | 1.31 | 1.59 | 1.51 | 33.2 | 36.5 |
| 153 | Example | Present | 1.9 | 1.07 | 1.33 | 1.62 | 1.51 | 33.7 | 36.7 |
| 154 | Example | Present | 1.8 | 1.10 | 1.39 | 1.78 | 1.49 | 33.0 | 36.6 |
| 155 | Example | Present | 1.8 | 1.23 | 1.58 | 2.01 | 1.44 | 33.1 | 36.8 |
| 156 | Example | Present | 1.7 | 1.05 | 1.32 | 1.55 | 1.51 | 33.2 | 36.6 |
| 157 | Example | Present | 1.7 | 1.08 | 1.34 | 1.59 | 1.51 | 33.0 | 36.7 |
| 158 | Example | Present | 1.9 | 1.12 | 1.38 | 1.81 | 1.49 | 33.5 | 36.5 |
| 159 | Example | Present | 1.8 | 1.23 | 1.55 | 1.99 | 1.44 | 33.3 | 36.8 |
| 160 | Example | Present | 1.7 | 1.09 | 1.28 | 1.56 | 1.51 | 33.2 | 36.8 |
| 161 | Example | Present | 1.7 | 1.06 | 1.33 | 1.58 | 1.50 | 33.8 | 36.7 |
| 162 | Example | Present | 1.7 | 1.13 | 1.39 | 1.78 | 1.48 | 33.2 | 36.5 |
| 163 | Example | Present | 1.9 | 1.25 | 1.52 | 2.02 | 1.43 | 34.0 | 36.8 |
| 164 | Example | Present | 1.9 | 1.10 | 1.35 | 1.57 | 1.51 | 33.3 | 36.6 |
| 165 | Example | Present | 1.7 | 1.05 | 1.28 | 1.61 | 1.50 | 34.0 | 36.7 |
| 166 | Example | Present | 1.9 | 1.13 | 1.39 | 1.76 | 1.47 | 33.4 | 36.8 |
| 167 | Example | Present | 1.8 | 1.25 | 1.56 | 1.98 | 1.43 | 33.7 | 36.9 |

TABLE 8B

| | Example/ | (Fe_{1-γ}X1_{γ})_{0.800}B_{0.120}P_{0.030}Si_{0.020}C_{0.010}Cr_{0.010}Mn_{0.010}, | | Gas | Gas Oxygen | Oxide |
|---|---|---|---|---|---|---|
| Sample | Comp. | α = 0, β = 0 | | Heating Temp. | Concentration | part |
| No | example | X1 | γ | (° C.) | (%) | Si |
| 97 | Example | — | 0.000 | 300 | 0.25 | Present |
| 168 | Example | Bi | 0.001 | 300 | 0.25 | Present |
| 169 | Example | Bi | 0.003 | 300 | 0.25 | Present |
| 170 | Example | Bi | 0.010 | 300 | 0.25 | Present |
| 171 | Example | Bi | 0.025 | 300 | 0.25 | Present |
| 172 | Example | La | 0.001 | 300 | 0.25 | Present |
| 173 | Example | La | 0.003 | 300 | 0.25 | Present |
| 174 | Example | La | 0.010 | 300 | 0.25 | Present |
| 175 | Example | La | 0.025 | 300 | 0.25 | Present |
| 176 | Example | Y | 0.001 | 300 | 0.25 | Present |
| 177 | Example | Y | 0.003 | 300 | 0.25 | Present |
| 178 | Example | Y | 0.010 | 300 | 0.25 | Present |
| 179 | Example | Y | 0.025 | 300 | 0.25 | Present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 97 | Example | Present | 1.7 | 1.06 | 1.29 | 1.56 | 1.51 | 33.5 | 36.6 |
| 168 | Example | Present | 1.7 | 1.04 | 1.30 | 1.57 | 1.51 | 33.0 | 36.5 |
| 169 | Example | Present | 1.7 | 1.07 | 1.33 | 1.58 | 1.50 | 33.1 | 36.8 |
| 170 | Example | Present | 1.8 | 1.12 | 1.37 | 1.77 | 1.48 | 33.8 | 36.9 |
| 171 | Example | Present | 1.7 | 1.24 | 1.54 | 1.97 | 1.44 | 33.4 | 36.7 |
| 172 | Example | Present | 1.8 | 1.06 | 1.32 | 1.58 | 1.51 | 33.6 | 36.6 |
| 173 | Example | Present | 1.9 | 1.05 | 1.30 | 1.61 | 1.50 | 33.2 | 36.7 |
| 174 | Example | Present | 1.6 | 1.14 | 1.38 | 1.81 | 1.46 | 33.3 | 36.9 |
| 175 | Example | Present | 1.7 | 1.23 | 1.58 | 2.03 | 1.39 | 33.9 | 36.7 |
| 176 | Example | Present | 1.9 | 1.04 | 1.33 | 1.53 | 1.50 | 33.8 | 36.6 |
| 177 | Example | Present | 1.7 | 1.06 | 1.31 | 1.56 | 1.50 | 33.6 | 36.7 |
| 178 | Example | Present | 1.8 | 1.10 | 1.37 | 1.78 | 1.47 | 34.0 | 36.8 |
| 179 | Example | Present | 1.8 | 1.24 | 1.55 | 2.00 | 1.42 | 33.6 | 36.6 |

TABLE 8C

| | Example/ | (Fe_{1-γ}X1_{γ})_{0.800}B_{0.120}P_{0.030}Si_{0.020}C_{0.010}Cr_{0.010}Mn_{0.010}, | | Gas | Gas Oxygen | Oxide |
|---|---|---|---|---|---|---|
| Sample | Comp. | α = 0, β = 0 | | Heating Temp. | Concentration | part |
| No | example | X1 | γ | (° C.) | (%) | Si |
| 97 | Example | — | 0.000 | 300 | 0.25 | Present |
| 180 | Example | Ga | 0.001 | 300 | 0.25 | Present |
| 181 | Example | Ga | 0.003 | 300 | 0.25 | Present |
| 182 | Example | Ga | 0.010 | 300 | 0.25 | Present |
| 183 | Example | Ga | 0.025 | 300 | 0.25 | Present |
| 184 | Example | Ti | 0.001 | 300 | 0.25 | Present |
| 185 | Example | Ti | 0.003 | 300 | 0.25 | Present |
| 186 | Example | Ti | 0.010 | 300 | 0.25 | Present |
| 187 | Example | Ti | 0.025 | 300 | 0.25 | Present |
| 188 | Example | Zr | 0.001 | 300 | 0.25 | Present |
| 189 | Example | Zr | 0.003 | 300 | 0.25 | Present |
| 190 | Example | Zr | 0.010 | 300 | 0.25 | Present |
| 191 | Example | Zr | 0.025 | 300 | 0.25 | Present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 97 | Example | Present | 1.7 | 1.06 | 1.29 | 1.56 | 1.51 | 33.5 | 36.6 |
| 180 | Example | Present | 1.9 | 1.03 | 1.34 | 1.55 | 1.51 | 33.9 | 36.5 |
| 181 | Example | Present | 1.9 | 1.05 | 1.30 | 1.54 | 1.50 | 33.6 | 36.8 |
| 182 | Example | Present | 1.7 | 1.11 | 1.39 | 1.77 | 1.47 | 33.8 | 36.8 |
| 183 | Example | Present | 1.9 | 1.22 | 1.53 | 2.05 | 1.42 | 33.9 | 36.7 |
| 184 | Example | Present | 1.7 | 1.04 | 1.29 | 1.54 | 1.51 | 33.2 | 36.8 |
| 185 | Example | Present | 1.6 | 1.04 | 1.30 | 1.59 | 1.50 | 33.8 | 36.7 |
| 186 | Example | Present | 1.8 | 1.15 | 1.41 | 1.79 | 1.46 | 33.7 | 36.9 |
| 187 | Example | Present | 1.9 | 1.25 | 1.59 | 2.01 | 1.40 | 33.7 | 36.7 |
| 188 | Example | Present | 1.9 | 1.03 | 1.31 | 1.57 | 1.51 | 33.1 | 36.9 |
| 189 | Example | Present | 1.9 | 1.05 | 1.33 | 1.59 | 1.51 | 33.5 | 36.7 |
| 190 | Example | Present | 1.7 | 1.14 | 1.42 | 1.81 | 1.46 | 34.0 | 36.8 |
| 191 | Example | Present | 1.7 | 1.21 | 1.58 | 1.99 | 1.39 | 33.1 | 36.9 |

TABLE 8D

| | Example/ | (Fe_{1-γ}X1_{γ})_{0.800}B_{0.120}P_{0.030}Si_{0.020}C_{0.010}Cr_{0.010}Mn_{0.010}, | | Gas | Gas Oxygen | Oxide |
|---|---|---|---|---|---|---|
| Sample | Comp. | α = 0, β = 0 | | Heating Temp. | Concentration | part |
| No | example | X1 | γ | (° C.) | (%) | Si |
| 97 | Example | — | 0.000 | 300 | 0.25 | Present |
| 192 | Example | Ag | 0.001 | 300 | 0.25 | Present |
| 193 | Example | Ag | 0.003 | 300 | 0.25 | Present |
| 194 | Example | Ag | 0.010 | 300 | 0.25 | Present |
| 195 | Example | Ag | 0.025 | 300 | 0.25 | Present |
| 196 | Example | As | 0.001 | 300 | 0.25 | Present |
| 197 | Example | As | 0.003 | 300 | 0.25 | Present |
| 198 | Example | As | 0.010 | 300 | 0.25 | Present |
| 199 | Example | As | 0.025 | 300 | 0.25 | Present |
| 200 | Example | Au | 0.001 | 300 | 0.25 | Present |
| 201 | Example | Au | 0.003 | 300 | 0.25 | Present |
| 202 | Example | Au | 0.010 | 300 | 0.25 | Present |
| 203 | Example | Au | 0.025 | 300 | 0.25 | Present |
| 204 | Example | Pt | 0.001 | 300 | 0.25 | Present |
| 205 | Example | Pt | 0.003 | 300 | 0.25 | Present |
| 206 | Example | Pt | 0.010 | 300 | 0.25 | Present |
| 207 | Example | Pt | 0.025 | 300 | 0.25 | Present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 97 | Example | Present | 1.7 | 1.06 | 1.29 | 1.56 | 1.51 | 33.5 | 36.6 |
| 192 | Example | Present | 1.7 | 1.06 | 1.32 | 1.59 | 1.51 | 33.6 | 36.8 |
| 193 | Example | Present | 1.8 | 1.07 | 1.35 | 1.62 | 1.50 | 33.9 | 36.7 |
| 194 | Example | Present | 1.7 | 1.13 | 1.37 | 1.78 | 1.46 | 33.7 | 36.5 |
| 195 | Example | Present | 1.7 | 1.25 | 1.56 | 2.01 | 1.40 | 33.5 | 36.8 |
| 196 | Example | Present | 1.8 | 1.06 | 1.33 | 1.56 | 1.51 | 33.7 | 36.7 |
| 197 | Example | Present | 1.7 | 1.05 | 1.31 | 1.58 | 1.51 | 33.3 | 36.6 |
| 198 | Example | Present | 1.6 | 1.13 | 1.39 | 1.77 | 1.47 | 33.5 | 36.8 |
| 199 | Example | Present | 1.8 | 1.24 | 1.56 | 1.98 | 1.41 | 33.7 | 36.7 |
| 200 | Example | Present | 1.7 | 1.04 | 1.32 | 1.57 | 1.51 | 33.7 | 36.8 |
| 201 | Example | Present | 1.8 | 1.07 | 1.29 | 1.59 | 1.50 | 33.8 | 36.5 |
| 202 | Example | Present | 1.7 | 1.12 | 1.38 | 1.76 | 1.46 | 33.4 | 36.6 |
| 203 | Example | Present | 1.9 | 1.22 | 1.54 | 1.98 | 1.39 | 33.7 | 36.7 |
| 204 | Example | Present | 1.8 | 1.08 | 1.32 | 1.58 | 1.51 | 33.4 | 36.8 |
| 205 | Example | Present | 1.8 | 1.05 | 1.33 | 1.57 | 1.51 | 33.9 | 36.5 |
| 206 | Example | Present | 1.7 | 1.14 | 1.39 | 1.76 | 1.46 | 33.3 | 36.8 |
| 207 | Example | Present | 1.8 | 1.25 | 1.54 | 2.03 | 1.40 | 33.5 | 36.7 |

TABLE 8E

| | Example/ | (Fe_{1-γ}X1_{γ})_{0.800}B_{0.120}P_{0.030}Si_{0.020}C_{0.010}Cr_{0.010}Mn_{0.010}, | | Gas | Gas Oxygen | Oxide |
|---|---|---|---|---|---|---|
| Sample | Comp. | α = 0, β = 0 | | Heating Temp. | Concentration | part |
| No | example | X1 | γ | (° C.) | (%) | Si |
| 97 | Example | — | 0.000 | 300 | 0.25 | Present |
| 208 | Example | Hf | 0.001 | 300 | 0.25 | Present |
| 209 | Example | Hf | 0.003 | 300 | 0.25 | Present |
| 210 | Example | Hf | 0.010 | 300 | 0.25 | Present |
| 211 | Example | Hf | 0.025 | 300 | 0.25 | Present |
| 212 | Example | Nb | 0.001 | 300 | 0.25 | Present |
| 213 | Example | Nb | 0.003 | 300 | 0.25 | Present |
| 214 | Example | Nb | 0.010 | 300 | 0.25 | Present |
| 215 | Example | Nb | 0.025 | 300 | 0.25 | Present |
| 216 | Example | Ta | 0.001 | 300 | 0.25 | Present |
| 217 | Example | Ta | 0.003 | 300 | 0.25 | Present |
| 218 | Example | Ta | 0.010 | 300 | 0.25 | Present |
| 219 | Example | Ta | 0.025 | 300 | 0.25 | Present |
| 220 | Example | Mo | 0.001 | 300 | 0.25 | Present |
| 221 | Example | Mo | 0.003 | 300 | 0.25 | Present |
| 222 | Example | Mo | 0.010 | 300 | 0.25 | Present |
| 223 | Example | Mo | 0.025 | 300 | 0.25 | Present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 97 | Example | Present | 1.7 | 1.06 | 1.29 | 1.56 | 1.51 | 33.2 | 36.6 |
| 208 | Example | Present | 1.8 | 1.06 | 1.32 | 1.59 | 1.51 | 33.3 | 36.6 |
| 209 | Example | Present | 1.9 | 1.07 | 1.35 | 1.62 | 1.50 | 33.2 | 36.8 |
| 210 | Example | Present | 1.7 | 1.13 | 1.37 | 1.78 | 1.48 | 33.0 | 36.9 |
| 211 | Example | Present | 1.8 | 1.25 | 1.56 | 2.01 | 1.43 | 33.4 | 36.8 |
| 212 | Example | Present | 1.9 | 1.05 | 1.33 | 1.55 | 1.51 | 33.1 | 36.7 |
| 213 | Example | Present | 1.8 | 1.06 | 1.32 | 1.58 | 1.50 | 33.5 | 36.8 |
| 214 | Example | Present | 1.9 | 1.15 | 1.38 | 1.76 | 1.46 | 33.4 | 36.9 |
| 215 | Example | Present | 1.8 | 1.24 | 1.55 | 1.98 | 1.39 | 33.8 | 36.7 |
| 216 | Example | Present | 1.8 | 1.06 | 1.32 | 1.56 | 1.51 | 33.8 | 36.9 |
| 217 | Example | Present | 1.8 | 1.08 | 1.31 | 1.59 | 1.51 | 33.8 | 36.8 |
| 218 | Example | Present | 1.9 | 1.17 | 1.39 | 1.77 | 1.45 | 33.5 | 36.7 |
| 219 | Example | Present | 1.7 | 1.28 | 1.54 | 2.04 | 1.38 | 33.1 | 36.6 |
| 220 | Example | Present | 1.9 | 1.04 | 1.33 | 1.55 | 1.51 | 33.4 | 36.8 |
| 221 | Example | Present | 1.7 | 1.06 | 1.35 | 1.59 | 1.50 | 33.4 | 36.5 |
| 222 | Example | Present | 1.8 | 1.14 | 1.40 | 1.75 | 1.46 | 33.4 | 36.9 |
| 223 | Example | Present | 1.8 | 1.27 | 1.59 | 2.02 | 1.41 | 33.7 | 37.0 |

TABLE 8F

| | Example/ | (Fe_{1-γ}X1_{γ})_{0.800}B_{0.120}P_{0.030}Si_{0.020}C_{0.010}Cr_{0.010}Mn_{0.010}, | | Gas | Gas Oxygen | Oxide |
|---|---|---|---|---|---|---|
| Sample | Comp. | α = 0, β = 0 | | Heating Temp. | Concentration | part |
| No | example | X1 | γ | (° C.) | (%) | Si |
| 97 | Example | — | 0.000 | 300 | 0.25 | Present |
| 224 | Example | V | 0.001 | 300 | 0.25 | Present |
| 225 | Example | V | 0.003 | 300 | 0.25 | Present |
| 226 | Example | V | 0.010 | 300 | 0.25 | Present |
| 227 | Example | V | 0.025 | 300 | 0.25 | Present |
| 228 | Example | W | 0.001 | 300 | 0.25 | Present |
| 229 | Example | W | 0.003 | 300 | 0.25 | Present |
| 230 | Example | W | 0.010 | 300 | 0.25 | Present |
| 231 | Example | W | 0.025 | 300 | 0.25 | Present |
| 232 | Example | Ca | 0.001 | 300 | 0.25 | Present |
| 233 | Example | Ca | 0.003 | 300 | 0.25 | Present |
| 234 | Example | Ca | 0.010 | 300 | 0.25 | Present |
| 235 | Example | Ca | 0.025 | 300 | 0.25 | Present |
| 236 | Example | Mg | 0.001 | 300 | 0.25 | Present |
| 237 | Example | Mg | 0.003 | 300 | 0.25 | Present |
| 238 | Example | Mg | 0.010 | 300 | 0.25 | Present |
| 239 | Example | Mg | 0.025 | 300 | 0.25 | Present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 97 | Example | Present | 1.7 | 1.06 | 1.29 | 1.56 | 1.51 | 33.2 | 36.6 |
| 224 | Example | Present | 1.9 | 1.06 | 1.32 | 1.56 | 1.50 | 33.0 | 36.7 |
| 225 | Example | Present | 1.9 | 1.07 | 1.31 | 1.53 | 1.50 | 33.3 | 36.7 |
| 226 | Example | Present | 1.9 | 1.15 | 1.39 | 1.69 | 1.45 | 33.3 | 36.9 |
| 227 | Example | Present | 1.7 | 1.19 | 1.51 | 1.85 | 1.40 | 34.0 | 36.5 |
| 228 | Example | Present | 1.8 | 1.07 | 1.31 | 1.55 | 1.51 | 33.2 | 36.6 |
| 229 | Example | Present | 1.9 | 1.05 | 1.33 | 1.53 | 1.51 | 33.1 | 36.9 |
| 230 | Example | Present | 1.9 | 1.14 | 1.38 | 1.70 | 1.46 | 33.2 | 36.5 |
| 231 | Example | Present | 1.7 | 1.25 | 1.58 | 2.01 | 1.40 | 33.4 | 36.8 |
| 232 | Example | Present | 1.8 | 1.05 | 1.30 | 1.52 | 1.51 | 34.0 | 36.8 |
| 233 | Example | Present | 1.9 | 1.05 | 1.31 | 1.53 | 1.50 | 33.9 | 36.9 |
| 234 | Example | Present | 1.8 | 1.13 | 1.36 | 1.67 | 1.48 | 33.6 | 36.7 |
| 235 | Example | Present | 1.9 | 1.19 | 1.51 | 1.83 | 1.44 | 33.9 | 36.9 |
| 236 | Example | Present | 1.8 | 1.04 | 1.29 | 1.53 | 1.51 | 33.9 | 36.8 |
| 237 | Example | Present | 1.9 | 1.06 | 1.30 | 1.52 | 1.50 | 33.5 | 36.7 |
| 238 | Example | Present | 1.8 | 1.11 | 1.35 | 1.66 | 1.47 | 33.6 | 36.5 |
| 239 | Example | Present | 1.7 | 1.18 | 1.49 | 1.84 | 1.42 | 33.6 | 36.7 |

TABLE 8G

| | Example/ | (Fe_{1-γ}X1_{γ})_{0.800}B_{0.120}P_{0.030}Si_{0.020}C_{0.010}Cr_{0.010}Mn_{0.010}, | | Gas | Gas Oxygen | Oxide |
|---|---|---|---|---|---|---|
| Sample | Comp. | α = 0, β = 0 | | Heating Temp. | Concentration | part |
| No | example | X1 | γ | (° C.) | (%) | Si |
| 97 | Example | — | 0.000 | 300 | 0.25 | Present |
| 240 | Example | S | 0.001 | 300 | 0.25 | Present |
| 241 | Example | S | 0.003 | 300 | 0.25 | Present |
| 242 | Example | S | 0.010 | 300 | 0.25 | Present |
| 243 | Example | S | 0.025 | 300 | 0.25 | Present |
| 244 | Example | O | 0.001 | 300 | 0.25 | Present |
| 245 | Example | O | 0.003 | 300 | 0.25 | Present |
| 246 | Example | O | 0.010 | 300 | 0.25 | Present |
| 247 | Example | O | 0.025 | 300 | 0.25 | Present |
| 248 | Example | N | 0.001 | 300 | 0.25 | Present |
| 249 | Example | N | 0.003 | 300 | 0.25 | Present |
| 250 | Example | N | 0.010 | 300 | 0.25 | Present |
| 251 | Example | N | 0.025 | 300 | 0.25 | Present |

| | Example/ | | | Coercivity | | | | Core | |
|---|---|---|---|---|---|---|---|---|---|
| Sample | Comp. | Max | [Mn]o − [Mn]m | (Oe) | | | σ s | Relative | Core |
| No | example | Mn | (at %) | Hc1 | Hc2 | Hc3 | (T) | Permeability | Q value |
| 97 | Example | Present | 1.7 | 1.06 | 1.29 | 1.56 | 1.51 | 33.2 | 36.6 |
| 240 | Example | Present | 1.9 | 1.05 | 1.31 | 1.51 | 1.51 | 33.7 | 36.8 |
| 241 | Example | Present | 1.9 | 1.06 | 1.32 | 1.52 | 1.51 | 33.6 | 36.7 |
| 242 | Example | Present | 1.8 | 1.05 | 1.34 | 1.53 | 1.48 | 33.0 | 36.6 |
| 243 | Example | Present | 1.8 | 1.07 | 1.33 | 1.50 | 1.45 | 33.2 | 36.9 |
| 244 | Example | Present | 1.8 | 1.05 | 1.31 | 1.49 | 1.51 | 33.8 | 36.5 |
| 245 | Example | Present | 1.8 | 1.06 | 1.30 | 1.51 | 1.51 | 33.0 | 36.8 |
| 246 | Example | Present | 1.9 | 1.04 | 1.28 | 1.50 | 1.48 | 33.2 | 36.9 |
| 247 | Example | Present | 1.8 | 1.07 | 1.32 | 1.53 | 1.44 | 33.9 | 36.7 |
| 248 | Example | Present | 1.7 | 1.08 | 1.31 | 1.53 | 1.51 | 33.8 | 36.9 |
| 249 | Example | Present | 1.9 | 1.05 | 1.30 | 1.50 | 1.51 | 33.9 | 37.0 |
| 250 | Example | Present | 1.9 | 1.08 | 1.32 | 1.51 | 1.48 | 33.5 | 36.6 |
| 251 | Example | Present | 1.7 | 1.09 | 1.30 | 1.49 | 1.45 | 33.2 | 36.8 |

Table 1 shows examples and comparative examples of which the gas heating temperature and the gas oxygen concentration during a gas atomization were changed. When the gas heating temperature was 250° C. or higher and the gas oxygen concentration was 0.01% or higher, the concentration distribution of Mn of the soft magnetic particle included in the soft magnetic metal powder showed a maximum concentration of Mn in the oxide part. As a result, the soft magnetic metal powder of low coercivity was obtained, and the magnetic core using the soft magnetic metal powder had a good Q value.

On the contrary, even in case the gas heating temperature was 100° C. or lower and in case the gas heating temperature was higher than 100° C. and the gas oxygen concentration was 0.00%, the concentration distribution of Mn of the soft magnetic metal particle included in the soft magnetic metal powder did not show the maximum concentration of Mn in the oxide part. As a result, the soft magnetic metal powder having a high coercivity, particularly the large size particle having a high coercivity, was obtained, and the magnetic core using the soft magnetic metal powder had a poor Q value.

Table 2A to Table 2C show examples and comparative examples of which the amount (f) of Mn was changed from that shown in Sample Nos. 19 to 24. According to Tables 2A to 2C, the larger the amount of Mn was, it was easier to obtain the concentration distribution of Mn of the soft magnetic metal particle included in the soft magnetic metal powder to have the maximum concentration of Mn in the oxide part, even when the gas oxygen concentration was low. Note that, when the amount (f) of Mn was 0.030, the coercivity of the soft magnetic metal powder increased compared to the case that the amount (f) of Mn was 0.028 or less.

The examples showing [Mn]o− [Mn]m≥0.2 had a decreased coercivity compared to the examples showing [Mn]o− [Mn]m=0.1. The examples showing [Mn]o− [Mn]m≤7.0 had a decreased coercivity compared to the examples showing [Mn]o− [Mn]m≥7.0.

Table 3 shows the examples and the comparative examples which were performed under the same conditions as Sample Nos. 19 to 30 except that Si was included. Regarding the experiment examples including Si, the average concentration of Si in the oxide parts from the twenty soft magnetic metal particles was higher than the average concentration of Si of the metal particles from the twenty soft magnetic metal particles. Sample Nos. 80 to 84 which were examples including Si had an enhanced Q value of the magnetic core compared to Sample Nos. 20 to 24 which were examples not including Si.

Table 4 shows examples which were performed under the same conditions except that the amount (c) of Si was changed from that shown in Sample Nos. 22 and 82. As the amount (c) of Si increased, the coercivity and as of the soft magnetic metal powder tended to decrease. Further, as the amount (c) of Si increased, the Q value of the magnetic core tended improve.

Table 5A and Table 5B show experiment examples including Cr which were different from of the experiment examples shown in Table 1 to Table 4. Regarding the case including Cr, when the concentration distribution of Mn of the soft magnetic metal particle included in the soft magnetic metal powder had the maximum concentration of Mn in the oxide part, then the soft magnetic metal powder with a low coercivity was obtained. Further, the magnetic core using such soft magnetic metal powder had a good Q value.

Samples having the amount (a) of B within a range of 0.020≤a≤0.200 showed a good coercivity compared to Sample No. 92 which had the amount (a) of B smaller than 0.020. Also, Sample No. 103 which had the amount (a) of B larger than 0.200 showed a good as.

Samples having the amount (b) of P was within a range of 0≤b≤0.060 showed a good σs compared to Sample Nos. 109 and 110 having the amount (b) of P larger than 0.060.

Samples having the amount (c) of Si within a range of 0≤c≤0.100 showed a good σs compared to Sample No. 118 having the amount (c) of Si larger than 0.100.

Samples having the amount (d) of C within a range of 0≤d≤0.050 showed a good coercivity compared to Sample No. 124 having the amount (d) of C larger than 0.050.

Samples having the amount (e) of Cr within a range of 0≤e≤0.040 showed a good σs compared to Sample No. 129 having the amount (e) of Cr of larger than 0.040.

Samples having the amount (f) of Mn within a range of 0<f≤0.028 showed a good coercivity compared to Sample No. 133 having the amount (f) Mn of larger than 0.028. Also, Sample No. 130 which did not include Mn showed a significantly increased coercivity, and the magnetic core using the soft magnetic metal powder showed a decreased Q value.

Table 6 shows the examples performed under the same conditions except that Co partially replaced Fe of Sample No. 97 of Table 5A. Even in case Co was included, when the concentration distribution of Mn of the soft magnetic metal particle included in the soft magnetic metal powder had the maximum concentration of Mn in the oxide part, the soft magnetic metal powder having a low coercivity was obtained. Further, the magnetic core using such soft magnetic metal powder showed a good Q value. Also, samples satisfying 0≤α≤0.700 showed a good σs compared to Sample No. 144 having α larger than 0.700.

Table 7 shows examples which were performed under the same conditions as Sample No. 97 of Table 5A except that Ni partially replaced Fe. Even in case Ni was included, when the concentration distribution of Mn of the soft magnetic metal particle included in the soft magnetic metal powder had the maximum concentration of Mn in the oxide part, then the soft magnetic metal powder with a low coercivity was obtained. Further, the magnetic core using the soft magnetic metal powder showed a good Q value. Note that, the higher the amount of Ni was, σs tended to be smaller. Also, samples satisfying 0≤β≤0.200 had a good σs compared to Sample No. 151 which had R larger than 0.200.

FIG. 8A to FIG. 8G show examples performed under the same conditions as Sample No. 97 of Table 5A except that X1 partially replaced Fe. Even in case X1 was included, when the concentration distribution of Mn of the soft magnetic metal particle included in the soft magnetic metal powder had the maximum concentration of Mn in the oxide part, then the soft magnetic metal powder with a low coercivity was obtained. Further, the magnetic core using the soft magnetic metal powder showed a good Q value. Note that, the higher the amount of X1 was, σs tended to be smaller.

### Experiment Example 2

In below, Experiment example 2 is described, and it should be noted that unless mentioned otherwise, Experiment example 2 was performed under the same conditions as Experiment example 1.

Regarding the soft magnetic metal powder of Sample No. 97 produced in Experiment example 1, a heat treatment was carried out under inert atmosphere having an oxygen concentration of less than 0.01% within a temperature range of 300 to 700° C. for 60 minutes. Results are shown in Table 9. Note that, regarding a thickness of the oxide part, thicknesses of twenty soft magnetic metal particles were measured from STEM images, and the average thereof was calculated.

TABLE 9

| | | Heat | | | | | | | | | | | |
|---|---|---|---|---|---|---|---|---|---|---|---|---|---|
| | Example/ | treating | Oxide | | | | Oxide part | Coercivity | | | | Core | |
| Sample | Comp. | Temp. | part | Max | [Mn]o − [Mn]m | Fine | thickness | (Oe) | | | σ s | Relative | Core |
| No | example | (° C.) | Si | Mn | (at %) | structure | (nm) | Hc1 | Hc2 | Hc3 | (T) | Permeability | Q value |
| 97 | Example | — | Present | Present | 1.6 | Amorphous | 6 | 1.06 | 1.29 | 1.56 | 1.51 | 33.1 | 36.6 |
| 252 | Example | 300 | Present | Present | 1.6 | Amorphous | 6 | 1.05 | 1.25 | 1.43 | 1.51 | 33.2 | 36.7 |
| 253 | Example | 600 | Present | Present | 1.6 | Nanocrystal | 6 | 0.91 | 1.04 | 1.21 | 1.51 | 33.4 | 36.7 |
| 254 | Example | 700 | Present | Present | 1.6 | Crystal | 6 | 1.29 | 1.99 | 2.76 | 1.51 | 33.1 | 36.1 |

According to Table 9, Sample No. 252 to which the heat treatment was carried out at 300° C. had a structure made of amorphous. Further, compared to Sample No. 97 to which the heat treatment was not carried out, Sample No. 252 showed decreased coercivity. Sample No. 253 to which the heat treatment was carried out at 600° C. had a structure made of nanocrystal. Further, compared to Sample Nos. 97 and 252, Sample No. 253 showed even more decreased coercivity. However, Sample No. 254 to which the heat treatment was carried out at 700° C. had a structure made of crystal. Further, compared to Sample No. 97, Sample No. 254 showed increased coercivity, and decreased Q value. Also, even when the heat treatment was carried out under inert atmosphere, regardless of the heat-treating temperature, the thickness of the oxide part did not change.

### Experiment Example 3

In below, Experiment example 3 is described, and it should be noted that unless mentioned otherwise, Experiment example 3 was performed under the same conditions as Experiment example 2.

Regarding the soft magnetic metal powder of Sample Nos. 252 to 254 produced in Experiment example 2, a heat treatment was carried out under inert atmosphere having an oxygen concentration within a range of 0.01 to 0.3% at a temperature of 300° C. for 60 minutes. Results are shown in Table 10.

TABLE 10

| | | Heat | | | | | | | | | | | |
|---|---|---|---|---|---|---|---|---|---|---|---|---|---|
| | Example/ | treating | Oxide | | | | Oxide part | Coercivity | | | | Core | |
| Sample | Comp. | Temp. | part | Max | [Mn]o − [Mn]m | Fine | thickness | (Oe) | | | σ s | Relative | Core |
| No | example | (° C.) | Si | Mn | (at %) | structure | (nm) | Hc1 | Hc2 | Hc3 | (T) | Permeability | Q value |
| 252 | Example | — | Present | Present | 1.6 | Amorphous | 6 | 1.05 | 1.25 | 1.43 | 1.51 | 33.2 | 36.7 |
| 255 | Example | 0.01 | Present | Present | 1.6 | Amorphous | 12 | 1.07 | 1.26 | 1.46 | 1.51 | 33.3 | 35.8 |
| 256 | Example | 0.1 | Present | Present | 1.6 | Amorphous | 47 | 1.05 | 1.27 | 1.44 | 1.51 | 33.2 | 35.3 |
| 257 | Example | 0.3 | Present | Present | 1.6 | Amorphous | 105 | 1.06 | 1.31 | 1.51 | 1.50 | 33.4 | 33.8 |
| 253 | Example | — | Present | Present | 1.6 | Nanocrystal | 6 | 0.91 | 1.04 | 1.21 | 1.51 | 33.4 | 36.7 |
| 258 | Example | 0.01 | Present | Present | 1.6 | Nanocrystal | 14 | 0.93 | 1.05 | 1.21 | 1.51 | 33.3 | 35.7 |
| 259 | Example | 0.1 | Present | Present | 1.6 | Nanocrystal | 48 | 0.92 | 1.04 | 1.23 | 1.51 | 33.1 | 35.2 |
| 260 | Example | 0.3 | Present | Present | 1.6 | Nanocrystal | 103 | 0.94 | 1.07 | 1.26 | 1.50 | 33.5 | 34.2 |
| 254 | Example | — | Present | Present | 1.6 | Crystal | 6 | 1.29 | 1.99 | 2.76 | 1.51 | 33.1 | 36.1 |
| 261 | Example | 0.01 | Present | Present | 1.6 | Crystal | 17 | 1.30 | 2.01 | 2.79 | 1.51 | 33.3 | 35.6 |
| 262 | Example | 0.1 | Present | Present | 1.6 | Crystal | 49 | 1.28 | 2.03 | 2.77 | 1.51 | 33.2 | 35.2 |
| 263 | Example | 0.3 | Present | Present | 1.6 | Crystal | 108 | 1.31 | 2.05 | 2.81 | 1.50 | 33.3 | 33.9 |

Regarding the soft magnetic metal powder to which the heat treatment was carried out under active atmosphere having an oxygen concentration of 0.1% or less, the thickness of the oxide part was 100 nm or less, and the soft magnetic metal powder having a low coercivity was obtained. Further, the magnetic core using the soft magnetic metal powder had a good Q value.

Regarding the soft magnetic metal powder of which the heat treatment was carried out under active atmosphere having an oxygen concentration of 0.3%, the thickness was thicker than 100 nm and 500 nm or thinner. Further, the coercivity and the Q value of the magnetic core decreased compared to the cases which were performed under the same conditions except that the thickness of the oxide part was 100 nm or less.

### NUMERICAL REFERENCE

1 . . . Soft magnetic metal particle
11 . . . Metal particle
13 . . . Oxide part

What is claimed is:

1. A soft magnetic powder comprising soft magnetic metal particles, wherein
the soft magnetic metal particles comprise metal particles and oxide parts covering the metal particles,
each of the metal particles at least include Fe,
each of the oxide parts at least include Fe and Mn, and
concentration distributions of Mn of the soft magnetic particles have maximum concentrations of Mn in the oxide parts.

2. The soft magnetic metal powder according to claim 1, satisfying [Mn]o−[Mn]m≥0.2, in which
[Mn]o (at %) represents an average of the maximum concentrations of Mn of the oxide parts, and
[Mn]m (at %) represents an average concentration of Mn of the metal particles.

3. The soft magnetic metal powder according to claim 1 satisfying [Mn]o−[Mn]m≤7.0, in which
[Mn]o (at %) represents an average of the maximum concentrations of Mn of the oxide parts, and
[Mn]m (at %) represents an average concentration of Mn of the metal particles.

4. The soft magnetic metal powder according to claim 1, wherein each of the metal particles at least include Fe and Si;
each of the oxide parts at least include Fe, Si, and Mn; and
an average concentration of Si of the oxide parts is higher than an average concentration of Si of the metal particles.

5. The soft magnetic metal powder according to claim 1, wherein the soft magnetic metal powder at least includes Fe and Si, and
an amount of Si is within a range of larger than 0 at % and 10 at % or less.

6. A magnetic core comprising the soft magnetic metal powder according to claim 1.

7. A magnetic component comprising the magnetic core according to claim 6.

8. An electronic device comprising the magnetic component according to claim 7.
